(19) United States
(12) Patent Application Publication
(10) Pub. No.: US 2012/0054112 A1
(43) Pub. Date: Mar. 1, 2012

(54) TECHNIQUES FOR CREATING MICROTASKS FOR CONTENT PRIVACY PRESERVATION

(75) Inventors: Michael J. Gormish, Redwood City, CA (US); Berna Erol, San Jose, CA (US); Jorge Moraleda, Menlo Park, CA (US); Timothee Bailloeul, Sunnyvale, CA (US); Xu Liu, Cupertino, CA (US); David G. Stork, Portola Valley, CA (US)

(73) Assignee: Ricoh Company, Ltd., Tokyo (JP)

(21) Appl. No.: 12/871,665

(22) Filed: Aug. 30, 2010

(51) Int. Cl. G06Q 10/00

(52) U.S. Cl. 705/301

(57) ABSTRACT

Techniques for performing a task while preserving the privacy or confidentiality of information used as input for the task. In one embodiment the task is broken down into smaller tasks (called subtasks or microtasks), which are then outsourced. The input information for each microtask is based upon and is generally a subset of the input information received for the task. The determination of microtasks for the task is performed in such a manner that constraints associated with the task are satisfied. For example, microtasks may be determined for the task based upon risk (e.g., the risk associated with the privacy or confidentiality of the input information being compromised as a result of the outsourcing), quality constraints (e.g., desired quality of the work product resulting from performance of the task), cost constraints, and other constraints associated with the job.

### CROSS-REFERENCES TO RELATED APPLICATIONS

The present application incorporates by reference for all purposes the entire contents of U.S. Non-Provisional application Ser. No. ______ (Attorney Docket No. 015358-013000US) entitled ______ filed concurrently with the present application on ______.

### BACKGROUND

Embodiments of the present invention relate to data processing systems and more particularly to techniques for performing task outsourcing while maintaining the privacy of the information used for the tasks.

In spite of advances in computer and artificial intelligence (AI) technologies, there are several tasks that can only be performed or alternatively performed efficiently or accurately, by a human using human intelligence. Examples of such tasks include object recognition in a photo or video, handwriting recognition, converting handwriting to type text, translations, transcriptions, and others. For these tasks, the accuracy obtained from performing the tasks using automated techniques does not come even close to the accuracy obtained when the tasks are performed by a human using human intelligence.

Due to their nature, such tasks are typically given to humans for completion. The humans performing the tasks are usually provided some compensation for performing the tasks. There are different ways in which the tasks are distributed to their intended human workers. With the advent of communication networks such as the Internet, several online communities have sprouted that enable the tasks to be distributed to the human workers electronically. Due to the expansive reach of the Internet, such tasks can now be electronically outsourced to human workers in diverse locations including different geographical locations in the US or even to workers in foreign countries where there is an availability of workers with the requisite skills for performing the tasks and who can perform the tasks at significantly reduced prices. The term “micro-outsourcing” is sometimes used to refer to the process of delivering tasks that require human intelligence to human workers and collecting the results from the performance of the tasks. For example, Amazon provides an online community called Amazon Mechanical Turk (AMT) that provides an online marketplace for work that requires human intelligence (such tasks are commonly referred to as human intelligence tasks or HITs). AMT provides a web-based micro-outsourcing service that provides a marketplace of human workers and work requesters. Using application programming interfaces (APIs) provided by AMT, work requesters can specify parameters for a HIT such as the task specification, the price for performing the task, the time frame for completing the task, the desired quality for the task, the desired location of the human worker who will perform the task, and the like. The most popular uses of AMT include audio transcription, writing blog entries, and image tagging. Services such as AMT thus enable companies to programmatically access a marketplace with a diverse, on-demand workforce for performing HITs.

While online systems such as the AMT have simplified the distribution of HITs to human workers, they fail to address several problems associated with the outsourcing. One of the biggest problems with outsourcing of HITs is how to preserve the confidentiality and privacy of information that is used as input for performing the tasks. Because of the distributed nature of the outsourcing model, traditional methods for maintaining privacy of the information are no longer effective. For example, companies that outsource tasks typically do not know the identity of a worker doing a task, do not have a direct agreement with the worker, and have no way to impose penalties for failure to maintain privacy. As a result, even though communities such as AMT exist, work requesters are apprehensive of using these services, especially when the information to be used for performing the HIT is confidential or private.

### BRIEF SUMMARY

Embodiments of the present invention provide techniques for performing a task while preserving the privacy or confidentiality of information used as input for the task. In one embodiment the task is broken down into smaller tasks (called subtasks or microtasks), which are then outsourced. The input information for each microtask is based upon and is generally a subset of the input information received for the task. The determination of microtasks for the task is performed in such a manner that constraints associated with the task are satisfied. For example, microtasks may be determined for the task based upon risk (e.g., the risk associated with the privacy or confidentiality of the input information being compromised as a result of the outsourcing), quality constraints (e.g., desired quality of the work product resulting from performance of the task), cost constraints, and other constraints associated with the job.

In one embodiment, information may be received identifying a task to be performed and input information for the task. A risk threshold may be determined or the task. A plurality of microtasks for performing the task may then be determined based upon the risk threshold. Each microtask may be associated with a portion of the input information. The plurality of microtasks may then be distributed to a plurality of workers. A plurality of work products resulting from performance of the plurality of microtasks by the plurality of workers may be received. A final work product for the task may then be generated based upon the plurality of work products resulting from performance of the plurality of microtasks.

The plurality of workers that perform the plurality of microtasks may include human workers and/or machines (automated processes). For example, the final work product may be generated by combining a first work product resulting from performance of a first microtask by a human worker and a second work product resulting from performance of a second microtask by a machine.

Various different techniques may be used to determine the plurality of microtasks for a task. These techniques may depend upon factors such as the risk threshold for the task, the expected quality threshold for the task, cost for performing the task, and the like. In one embodiment, the input information may be segmented into a set of segments based upon the risk threshold, each segment comprising a portion of the input information. Further, depending upon the risk threshold, one or more combined segments may be created based upon the set of segments and the risk threshold, The combined segments may comprise a combined segment that comprises information from at least one segment from the set of segments and additional data not included in the input information. Another combined segment may comprise information from at least two different segments from the set of segments. The plurality of microtasks may be determined based upon the set of combined segments.

The input information received for a task may be in different forms. In one embodiment, the input information may comprise multiple documents including a first document and a second document. In such a scenario, the set of segments may comprise a first segment comprising a portion of the first document and a second segment comprising a portion of the second document. The set of combined segments may comprise a first combined segment comprising contents of the first segment and the second segment. The plurality of microtasks may comprise a first microtask to be performed using the first combined segment as input.

In one embodiment, a quality estimate may be provided for the final work product for the task. The quality estimate may be based upon quality estimates associated with the plurality of work products resulting from performance of the plurality of microtasks. In one embodiment, a second set of microtasks may be determined for the task based upon the quality estimate.

In one embodiment, a quality threshold may be determined for the task. The quality threshold may be determined based upon information provided by a task requester or based upon other information. The plurality of microtasks may be determined based upon both the risk threshold and the quality threshold.

Various different tasks and associated input information may be provided. Examples include but are not restricted to: the input information is an image and the task is to recognize a set of words or objects in the image; the input information is an image and the task is to provide a symbolic representation of the image; and the like.

The foregoing, together with other features and embodiments will become more apparent upon referring to the following specification, claims, and accompanying drawings.

### BRIEF DESCRIPTION OF THE DRAWINGS

FIG. 1 is a simplified diagram of a system that may incorporate an embodiment of the present invention;

FIG. 2 depicts a simplified flowchart describing a high-level method for performing a task while preserving the privacy of the contents of input information received for the task according to an embodiment of the present invention;

FIG. 3 depicts a simplified flowchart describing processing performed for segmenting input information according to an embodiment of the present invention;

FIG. 4 depicts a simplified flowchart describing processing performed for generating combined segments according to an embodiment of the present invention;

FIG. 5 depicts a simplified flowchart showing processing performed by a microtask generator subsystem according to an embodiment of the present invention;

FIG. 6 depicts a simplified flowchart showing processing performed by a distribution system according to an embodiment of the present invention;

FIG. 7 depicts a simplified flowchart describing processing performed for generating a final work product for a task based upon microtask products received for microtasks corresponding to the task according to an embodiment of the present invention;

FIGS. 8A and 8B depict an example describing various aspects of an embodiment of the present invention;

FIG. 9 is a block diagram for a system for determining a price for a micro task according to an embodiment of the present invention;

FIG. 10 is a flow diagram of a process for determining pricing for a task according to an embodiment of the present invention;

FIG. 11 illustrates a handwriting recognition application according to an embodiment of the present invention;

FIG. 12 illustrates a receipt recognition application according to an embodiment of the present invention;

FIG. 13 illustrates a business card recognition application according to an embodiment of the present invention;

FIGS. 14A and 14B illustrate a drawing conversion application according to an embodiment of the present invention; and

FIG. 15 is a simplified block diagram of a computer system that may be used to practice an embodiment of the present invention.

### DETAILED DESCRIPTION

In the following description, for the purposes of explanation, specific details are set forth in order to provide a thorough understanding of embodiments of the invention. However, it will be apparent that the invention may be practiced without these specific details.

Embodiments of the present invention provide techniques for performing a task while preserving the privacy or confidentiality of information used as input for the task. In one embodiment the task is broken down into smaller tasks (called subtasks or microtasks). The input information for each microtask is based upon and is generally a subset of the input information received for the task. The determination of microtasks for the task is performed in such a manner that constraints associated with the task are satisfied. For example, microtasks may be determined for the task based upon risk (e.g., the risk associated with the privacy or confidentiality of the input information being compromised as a result of the outsourcing), quality constraints (e.g., desired quality of the work product resulting from performance of the task), cost constraints, and other constraints associated with the job.

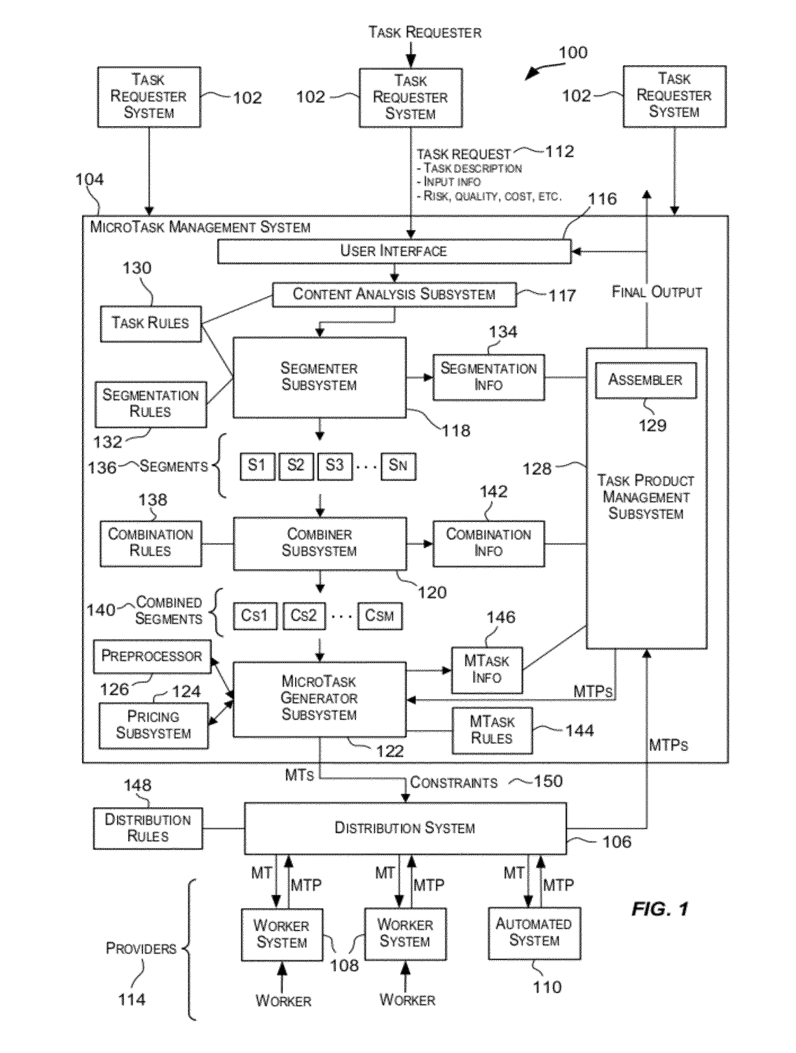

FIG. 1 is a simplified diagram of a system 100 that may incorporate an embodiment of the present invention. System 100 comprises multiple systems including one or more task requester systems 102, a microtask management system (MMS) 104, a distribution system 106, and one or more systems 108 and 110 that may be used to perform the outsourced microtasks. The various systems depicted in FIG. 1 may be coupled to one another via one or more communication networks (not shown in FIG. 1). These communication networks may be of the same or different types including the Internet, an Intranet, a local area network (LAN), a wide area network (WAN), an Ethernet network, or any communication network/infrastructure that enables communications between the systems. The communication networks may use different communication protocols including wired or wireless protocols for the communication. System 100 depicted in FIG. 1 is merely an example of an embodiment incorporating the teachings of the present invention and is not intended to limit the scope of the invention as recited in the claims.

At a high level, MMS 104 receives a task request from a task requester. The task request may identify a task to be performed and information to be used as input for performing the task. MMS 104 is configured to facilitate performance of the task while taking steps to preserve the privacy of the input information for the task. In one embodiment, MMS 104 is configured to determine a set of tasks (referred to as subtasks or microtasks) to be outsourced corresponding to the task to be performed and determine portions of the input information to be used as input for the microtasks. The division of the task into microtasks is performed with a view towards preserving the privacy of the input information received for the task (or in other words, with a view towards lowering the risk of the privacy or confidentiality of the input information being compromised as a result of outsourcing the microtasks). In one embodiment, the task request may also specify an acceptable risk threshold for the task. This risk threshold is then taken into consideration for subdividing the task into microtasks. The task request may also specify others factors related to the task such as acceptable cost of performing the task, the desired quality for the output generated as a result of performing the task, and others. These various factors may also be considered when determining how to subdivide the task into microtasks. MMS 104 then forwards the microtasks and their respective input information to a distribution system for distribution or outsourcing to providers 114 that perform the microtasks.

Providers 114 may include human workers and/or automated systems (machines) 110. The term “worker” as used in this application may refer to a human worker or a machine that performs a task or microtask. A human worker may use a system 108 to perform the microtask allocated to that worker. Providers 114 may be located in different geographical locations. Automated systems or machines 110 may include computer systems and applications. While only one distribution system 106 is depicted in FIG. 1, MMS 104 may be configured to work with multiple distribution systems.

MMS 104 is configured to receive the microtask work products corresponding to the set of microtasks for a task. The microtask work products may be received from distribution system 106 or directly from one or more workers. MMS 104 is configured to, based upon the received microtask products, construct a final product (final output) for the task requested in the task request. In one embodiment, MMS 104 is configured to aggregate the microtask products to generate the final output product for the task. The work product for the task may then be provided to the task requester. Further details are provided below.

As previously discussed, there are several tasks that can only be performed or alternatively can be performed more efficiently or accurately by a human using human intelligence. As a result, these tasks are best performed using human processing or a combination of human and machine processing. These tasks typically involve analysis, summary, or processing of inputs (input information) provided for the task. For example, given an image of a document, the task may involve generating an output comprising a symbolic representation of the document image. The symbolic representation may include words extracted from the document image and names of any objects pictured on the document pages. As another example, given audio information, the task may involve generating a transcription of the audio information. As yet another example, the input information may include unstructured information (e.g., a text file) and the task may be to put the information into a structured format (e.g., enter the information into a spreadsheet).

For any task to be performed, there are several factors associated with the task such as cost, risk associated with getting the task performed by a human or by a machine worker, expected quality of the work product for the task, and others. For example, there may be some risk associated in providing the information contained in the task input to a human or machine. For example, if the input information comprises a handwritten list of names, addresses, and phone numbers provided by a company, providing the input information to a human or even to an external machine moderated processing system might violate a privacy policy of the company or lead to a lack of trust in the institution dealing with the information. This risk is particularly heightened in automated online outsourcing scenarios where the humans or machines performing the task are typically not known to the task requester.

In one embodiment, MMS 104 is configured to outsource the task in a way that takes into consideration the various factors that may be associated with the task. For example, MMS 104 is configured to perform the outsourcing, including the division of the task into microtasks, with a view towards reducing the risk (i.e., the risk that the privacy or confidentiality of the input information will be compromised as a result of the outsourcing) associated with outsourcing the task and its input information. MMS 104 may use various different techniques to achieve this. For example, in many cases, MMS 104 may control the input information that is provided to each worker. This may be done by limiting the amount of input information that is exposed to each worker or even by modifying the information provided to a worker.

Various segmentation and/or combination techniques may be used to limit and/or modify the input information provided to workers. In one embodiment, a segmentation technique may be used such that only a subset of the input information is provided to a worker performing a microtask. The worker is still able to provide some analysis, summary, or processed version of the input information provided to that worker, but due to the whole input information not being available to the worker, the overall risk associated with dissemination of the input information received for the task is greatly reduced. For example, if the input information for a task comprises an image of names with associated addresses and phone numbers, the input image may be segmented into three images: a first image comprising only the names, a second image comprising only the phone numbers, and a third image comprising only the addresses. Each image segment may then be provided to a separate worker with the microtask being to generate textual information corresponding to each image segment. In this manner, no single worker has access to all the input information. This reduces the risk associated with the release of a name and its associated address and phone number being known by a worker.

The input information provided to a worker for a microtask can be modified in a variety of ways to further reduce the risk such as using combination techniques. For example, in the situation where the input information comprises an image of names with associated addresses and phone numbers, as described above, just an image of the phone numbers may be provided to a worker. To further reduce the risk of confidential information being known, the image of phone numbers may be combined with images of other phone numbers, even fake phone numbers. The modified image of phone numbers may then be provided to a worker—this reduces the risk associated with disclosure of the phone numbers to a worker since the worker has no knowledge of how the input information provided to the worker has been modified. The worker is still able to perform the microtask allocated to the worker (which may be to convert the image to textual information).

In general, the risk associated with a task may be expressed as follows. Let I be the complete input information for a task. Let O be the complete output (or work product) generated from performing the task on the input I. The complete output, O, could be obtained by providing the whole input information to a single worker, W, written as O=W(I). However, there is a risk, R, associated with providing the entire input information to a single worker. The risk is of the privacy/contents of the input information being compromised. This risk, R, depends on the worker and the input information provided and may be expressed as R(I,W). The R(I,W) might be unacceptably high. To reduce the overall risk, the input I can be modified. For example, the input I can be subdivided into subsets, I₁, I₂, . . . , Iₙ, with a subset and its associated microtask being provided to a worker Wᵢ. Each worker (Wᵢ) can perform the microtask allocated to that worker and produce an output (Oᵢ) based on the input (Iᵢ) received, where Oᵢ=Wᵢ(Iᵢ). The final output, O, is an assembled version of the outputs Oᵢ from the workers Wᵢ. Accordingly, O=Assemble(O₁, O₂, . . . , Oₙ). The risk associated with such a technique is a combination of the risks associated with providing the subsets of the inputs to different workers. If the risk of exchange of information between workers is small enough, then the overall risk R is approximately, R=ΣR(Iᵢ,Wᵢ), where R(Iᵢ,Wᵢ) is the risk associated with providing worker Wᵢ, with input subset Iᵢ. In one embodiment, the input information modification done by MMS 104 is such that ΣR(Iᵢ,Wᵢ) is less than R(I,W).

Another factor that may be associated with a task is the expected quality of the output resulting from performance of the task. Accordingly, there is a certain quality, Q, that can be obtained by giving a worker, W, input I, which can be expressed as Q(I,W). In general, quality can be thought of as closeness to the “desired” or “correct” output, of course in many cases the “correct” output is unknown and can only be estimated. It is desired that outsourcing for a task be performed in a way that not only reduces the risk but also maximizes the quality of the task output.

Yet another factor that may be associated with a task is the cost for performing the task. There is a cost associated with having a worker operate on an input to produce an output. This cost may be represented as C(Wᵢ,Iᵢ). Typically, the cost of performing a task by a machine-implemented process is less than the cost of a human worker, but the quality of the output may also be less.

The notation W is used for worker, where the worker may be an automated process (machine) or a human worker. There is also a difference in risk in various workers. For example, the risk (i.e., the risk of the privacy or confidentiality of the input information being compromised as a result of outsourcing a task or microtask to the worker) associated with an automated process is often less than that associated with a human worker, in part because the automated process may be under better control of the entity providing the original input for the task, I. Because risk varies with both the worker and the input provided, it may reduce risk to provide the output from one worker as the input to another worker or to provide a greater portion of the input to a machine worker and a smaller portion to a human worker. For example, only a subset of the input provided to a machine worker may be provided to a human worker. For example, an automated process might operate on all the words in an input image, and generate symbolic output for many of them, but be unable to process some of the words in the input image, perhaps because they are poorly written. In this case, only those parts of the input image that the automated process had difficulty with might be passed on as input to a human worker.

While in general the risk associated with a particular worker is initially unknown, the risk can be estimated based on experience and may depend on the worker location, worker education level, worker income, worker approval rating, and many other characteristics of the worker. Some of these characteristics may be estimated by the MMS 104 over time, by gathering experience with workers in different situations, some may be estimated by other means. In some cases risk might be lower if a particular task distribution system provided contracts, nondisclosure agreements, or bonds associated with the workers. Thus, the risk associated with giving a particular input to a particular worker, R(I,W), may be estimated based on multiple factors.

The input information provided to a worker as part of the outsourcing may also be modified by adding “noise” to the input information. For example, an automated process may be used to modify the input by adding “noise” to the input before the input is provided to a human worker. As mentioned above, images of fake phone numbers could be added before the image of a real phone number is provided to a human worker. In this case, the outputs corresponding to the microtasks may be represented as O₁=W_{machine}(I₁), and I₂=O₁, and O₂=Wₕᵤₘₐₙ(I₂). Accordingly, a first microtask provided to a machine adds noise to input information I₁ to produce output O₁. The output O₁ of the first microtask is then provided as input (I₂) of another microtask allocated to a human worker. There is a reduction in risk in this sequence of processing, because R(I₂, Wₕᵤₘₐₙ)<R(I₁, Wₕᵤₘₐₙ.), and R(I₁, W_{machine}) is very small because it is an automated process.

Another type of noise that can be added to reduce risk is blurring or other distortion to images (input) provided to workers. For example, an input image might contain humans and objects to be recognized. If the image is provided as is, the human identities might be recognized. However, if some blurring is applied to the input image in appropriate spots, the worker may be unable to identify the human but still able to identify objects in the image, e.g., cars, sky, buildings, etc. In this case, R(I,W)>R(Distorted(I),W). In this case, the quality of the identification task may be impaired by distorting the image, so in this case Q(I,W)>Q(Distorted(I),W). Accordingly, depending upon the task requestor's expectation, a balancing may be performed between the risk and quality parameters.

“Noise” may also be added to the input for quality control purposes. For example, the “noise” injected by an automated process might also include input information where the desired outputs are known. For example, phone number images where the symbolic phone number is known. This allows the quality of the output to be evaluated. If a human worker provides an output which does not contain the correct answers for the known portion, MMS 104 is able to assign a low quality estimate to the work done by that worker for that task. If the low quality estimate is below the requested quality, the task might be assigned to another worker and again the quality of the new job can be estimated to see if it meets the quality requirements.

There is also a risk associated with giving the same worker information related to previous tasks the worker has accomplished, because this enables the worker to accumulate information and potentially release it. For example if the same worker is provided with an image of a social security card and an application form from the same person, that worker may have too much information about the applicant. Thus, in general, R(I₁+I₂,W₀)>(R(I₁,W₁)+R(I₂,W₂)).

As previously indicated, while minimizing risk R, it is also desirable to maximize the quality of the final output. It may not be possible to do both simultaneously in some cases with cost constraints, and thus an operating point with some acceptable output quality and some acceptable risk may be chosen. Further, while the quality and risk may be described in equations, the precise risk and quality depends on each input and thus it may only be possible to estimate the risk and quality. Accordingly, a set of guidelines or rules may be used to attempt to achieve these goals when the impact of the division of the input is not known precisely. For example, when higher privacy (i.e., risk is to be lowered) is desired a task may be split into more microtasks, each microtask having a subset of the overall input as its input. Accordingly, in one embodiment, the higher the desired privacy level (i.e., tolerable risk is low), the greater the number of microtasks for a task, which in turn implies greater division of the input information provided for the task. For example, there may be one risk level estimated in sending the whole document as input for a microtask to one worker, a lower risk level associated with dividing the document into two halves and sending one half to one worker and the other half to another worker, a minimal risk level associated with dividing the input document into more than two parts (e.g., breaking the document on a per line basis) and sending each part (e.g., each line) to a separate worker, and so on. In this manner, the level of acceptable risk may be used as a factor to determine how the division of the task into microtasks is to be performed.

In many cases, splitting an input between multiple workers results in lower quality, e.g., ΣQ(Iᵢ,Wᵢ) is less than Q(I, W). In some cases, however, splitting can improve quality (i.e., ΣQ(Iᵢ,Wᵢ)>Q(I,W)), for example, one worker may be particularly adept at recognizing phone numbers and another at recognizing characters in a particular language, so in this case splitting the task such that the microtasks are allocated to workers who are adept at performing the microtasks can both increase quality while decreasing risk.

Multiple operations can be used to increase quality. For example, multiple workers may be asked to perform the same microtask on the same data and their work products compared to determine the quality level. In another situation, a work product generated by one worker as a result of performing a microtask may be checked (as part of another microtask) by another worker, who may be human or a machine. Using additional microtasks with additional workers does increase the distribution of information and may potentially increase the overall risk associated with completion of the task.

Human workers can be used to improve the quality of work on a subset of the input. For example, a human might be given the output or work product of an automated process and asked to check it. First, the automated process does O₁=W_{machine}(I₁), then the human produces O₂=Wₕᵤₘₐₙ(I₁,O₁), where the second output is a corrected form of the automated process. A task or microtask performed by an automated process (machine) can have some expected quality, Q_{machine} based on previous operation of the automated process, or in some cases automated tasks can self report quality based on the input. For example, an automated task recognizing letters might report 99% likely ‘c’ and 1% likely ‘e’, and this might be considered medium quality. But if the automated task reports 90% likely ‘c’ and 10% likely ‘e’, this would considered as low quality, and probably will need additional processing or correction. Because the human is only doing corrections, the cost associated with the overall task is lower than having the human operate on the original input, thus C(Wₕᵤₘₐₙ,I₁,O₁)+C(W_{machine},I₁)<C(Wₕᵤₘₐₙ,I₁).

In one embodiment the quality Q of a task or microtask may be measured using automated techniques. One such automatic technique can be a function of the number of words Nᵢ submitted by a worker Wᵢ and the number of words M detected by an automatic word boundary detection algorithm in the corresponding microtask (for example a document image). In this case quality Q is measured as: Q=f(M,Nᵢ). Another function may use the ratio of M to N, Q=M/N and another function may be Q=M−N/M. In one embodiment if more than one worker submits the result for a particular job then the automated quality detection could be a function that depends on all the outputs Q=f(N₁, . . . N₁). In one case f may be 1/cumulative_edit_distance(N₁ . . . Nᵢ). In another case Q=(min(N₁ . . . Nᵢ)/max(N₁ . . . Nᵢ)).

In one embodiment, if the input and output are images (or can be converted into images), the job quality Q can be measured by comparing the normalized gray level or color histogram Hᵢ of the input image to the normalized gray level or color histogram Hₒ of the task output. In this case Q=f(Hᵢ, Hₒ).

If the same worker performs several similar types of tasks, either in immediate succession, or over time, that work product can be used to estimate the quality produced by the worker. At the simplest level, the worker quality might be based on the previous acceptance rate of tasks. More accurate estimates of the worker quality might take into account performance on known inputs, as discussed earlier. With sufficient data worker quality estimates can take into account worker fatigue (lowering the quality estimate after many successive tasks), or time of day the worker is performing the task in their time zone. If there is insufficient data on a specific worker to estimate the worker's quality, a rough initial estimate might be based on performance on other tasks, or any similarities with other workers for which there is more data, e.g., geographic location, language skills. It is also possible to assign an initial task to workers to establish a quality estimate for various types of tasks.

In one embodiment, MMS 104 of system 100 embodies the above discussed principles. Rules may be configured for MMS 104 that control how a task is to be divided into microtasks while taking into consideration various factors such as the acceptable risk threshold for the task, the desired quality level for the task, acceptable cost threshold for the task, whether the microtasks are to be performed by human or automated workers, and others discussed above. Details related to processing performed by system 100 are provided below.

Referring to system 100 depicted in FIG. 1, a task or work requester may use a system 102 to communicate a task request 112 to MMS 104. A task requester may be a human, a machine, a software application/process, and the like. In one embodiment, a task requester may interact directly with MMS 104 to configure a task request. MMS 104 may receive multiple task requests from multiple task requesters. In this manner, MMS 104 may at any time service multiple requesters and process multiple task requests.

A task request 112 received by MMS 104 may comprise a task description that identifies the task to be performed. The task may be a human intelligence task (HIT) or other task. A task request may specify one or more tasks to be performed. Examples of HITs that may be requested include but are not restricted to:

Converting handwriting or text from an image to type text (e.g., typing contact information from one or more business cards, typing customer filled form data to an Excel spreadsheet, typing document modifications, typing information from a business card into contact information stored in a database);

Converting graphics (e.g., a hand-drawn graphic, a logo) to a computer drawing (e.g., converting a graphic from an image to a VISIO drawing, converting a whiteboard image to a PowerPoint slide);

Tagging/Describing objects, images, documents via metadata (e.g., entering the names of people in a photograph);

Classifying objects, images, documents (e.g., classifying documents as invoices vs. tax forms);

Finding objects, images, documents in a digital repository (e.g., find all versions of document A, find a Linked-in URL for person A); and

Defining relationships between objects, images, documents (e.g., invoice A relates to form B).

A task request 112 received by MMS 104 may also comprise information that is to be used for performing the requested task, i.e., the input information for the task. The input information may depend upon the task to be performed and may include one or more types of information including but not limited to text information, image information, audio information, video information, graphics, handwriting information, and other types of information, and combinations thereof. The input information for a task may be provided in various different forms. In one embodiment, the input information may be provided in the form of one or more documents, each document comprising information of one or more types. An input document could be a text file, a file generated by a scanner, a file generated by a word-processing program, an image or photograph, an audio file, a video file, and the like. For example, an input document may be an image of a business card, receipt, handwritten note, a label, a sign, an invoice, a photo, a form or drawing, newspaper articles, checks, objects, and the like.

As indicated above, the input information provided for a task typically depends on the task to be performed. For example, if the task to be performed is audio transcription, the input information may comprise one or more audio files that are to be transcribed. As another example, if the task is to translate from a first language to a second language, the input information may comprise one or more documents in the first language that are to be translated. As yet another example, if the task is to identify/tag objects in an image, the input document may be one or more images. Accordingly, the contents of the input information provided for a task may depend upon the type of task (or tasks if the input information is to be used for multiple tasks) to be performed.

Referring back to FIG. 1, in addition to the task description and input information, task request 112 received by MMS 104 may also optionally comprise other information related to the task to be performed. For example, the task request may specify criteria to be used for performing the task such as information related to a desired price/cost for performing the task, a desired or acceptable level of risk associated with the task, a time frame for completing the task, the desired quality for the task output, the desired location of the workers who will perform the task, the type of workers to be used (e.g., human versus machine), distribution constraints, and other information. This additional information is then used by MMS 104 for creating microtasks, segmenting the input information, distributing the microtasks, and the like.

In one embodiment, task request 112 may also comprise information identifying one or portions of the input information whose privacy is to be preserved. This enables the task requester to specifically identify portions of the input information that are important to the requester and whose privacy is to be preserved. For example, for a task involving generating text corresponding to contents of a scanned image (e.g., an image of a business card), the task requester may specify that the privacy of the name of the person, the position of the person, the employer of the person, and the address of the employer is to be preserved. Task request 112 may also include an overall level of acceptable risk that can be taken with the supplied data. This information may be used by MMS 104 to determine how to divide the task into microtasks while satisfying the various factors (e.g., risk, quality, cost, etc.) specified for the task.

MMS 104 may comprise several subsystems that facilitate the various functions performed by MMS 104. In the embodiment depicted in FIG. 1, MMS 104 comprises a user interface subsystem 116, a content analysis subsystem 117, a segmenter subsystem 118, a combiner subsystem 120, a microtask generator subsystem 122, a pricing subsystem 124, a preprocessor subsystem 126, and a task product management subsystem (TPMS) 128. The various subsystems of MMS 104 may be implemented in hardware, software (e.g., code, program, instructions executed by a processor of MMS 104), or combinations thereof. The software may be stored on a computer-readable storage medium. The processing performed by each of the subsystems is described below in further detail.

A set of rules may be configured for MMS 104 that control the processing performed by MMS 104. These rules control various processing functions performed by MMS 104 for performing task outsourcing such that the various factors or constraints specified for the task such as those related to risk level, quality, cost, etc. are satisfied. For example, with respect to risk, these rules control how a particular task is to be subdivided into microtasks such that the risk level specified for the task is satisfied. As another example, with respect to quality, these rules control how a particular task is to be subdivided into microtasks such that the overall quality of the output generated from performing the task meets the specified quality threshold. In situations where the risk has to be balanced with quality, these rules may be used to determine microtasks for a task such that the risk level is satisfied while maximizing the quality. For the embodiment depicted in FIG. 1, the set of rules include task rules 130, segmentation rules 132, combination rules 138, microtask rules 144, distribution rules 148, and rules used by pricing subsystem 124.

There are various ways in which the factors that affect a task and which affect the division of the task into microtasks are specified. As described above, a task requestor may specify one or more of these factors in the task request. Alternatively, default factors may be configured for MMS 104. MMS 104 may also be configured to determine a set of factors to be used for a task based upon the nature of the task to be performed (e.g., based upon the task itself, the nature of the input information, etc.).

MMS 104 may optionally comprise user interface subsystem 116 that is configured to provide an interface for providing information to MMS 104 and for MMS 104 to output information (e.g., to a task requester system 102 or to a task requester). In one embodiment, user interface subsystem 116 may provide a set of graphical user interfaces (GUI) that enable a user such as a task requester to interact with MMS 104. For example, GUIs may be provided that enable a task requester to configure task requests, provide information associated with task requests, view final work products for the tasks, and the like. GUIs may also be provided that enable a task requester to configure the processing performed by MMS 104. For example, a task requester may use user interface 116 to configure rules or criteria that affect the processing performed by one or more components of MMS 104.

User interface subsystem 116 may also provide a set of application programming interfaces (APIs) that users of MMS 104 may use to control the operations of MMS 104. For example, APIs may be provided that enable a task requester to specify the task to be performed, the input information for the task, and other criteria related to how the task is to be performed. In one embodiment, user interface subsystem 116 is configured to receive task requests 112 and to forward the task requests to content analysis subsystem 117 for further processing.

Content analysis subsystem 117 is configured to analyze a task request and associated information. As part of the analysis, content analysis subsystem 117 may be configured to recognize the type of task to be performed, determine the type of input received for the task, determine constraints, if any, imposed upon the task to be performed, and the like. Information gleaned by content analysis subsystem 117 from performing the analysis may then be used by other subsystems of MMS 104. For example, the analysis performed by content analysis subsystem 117 may be used by the other subsystems of MMS 104 to select rules to be used for processing related to determining microtasks for the task. For example, the analysis performed by content analysis subsystem 117 may be used by segmenter 118 to determine the task rules and/or segmentation rules to be used by segmenter 118 for the task. For example, content analysis subsystem 117 may determine that the input for a task is an image and then execute one or more algorithms to further classify the input image as being a whiteboard image, business card, a document image, etc. The classification information determined by content analysis subsystem 117 may then be used by segmenter 118 to select appropriate segmentation rules for segmenting the input image.

In some situations, the task request may not even identify the task to be performed but only specify the input information. Content analysis subsystem 117 may be configured to analyze the input information and automatically determine the task to be performed. Content analysis subsystem 117 may use task rules 130 to automatically determine the task to be performed.

The task request may identify one or more factors or constraints (e.g., risk, quality, etc.) to be associated with a task. Content analysis subsystem 117 may be configured to recognize these constraints and convey the information to other subsystems of MMS 104. In one embodiment, content analysis subsystem 117 may also be configured to determine a set of factors to be used for the task based upon the analysis. For example, if a risk level is not specified in the task request, the analysis performed by content analysis subsystem 117 may be used to determine a risk level or threshold to be associated with the task.

As indicated above, content analysis subsystem 117 may use task rules 130 to automatically determine the task to be performed. In one embodiment, a task rule may identify a condition and a task to be performed when the condition is met, or alternatively, when the condition is not met. The condition for a task rule may be based upon one or more criteria such as the identity of the task requester, the type of information contained in the input information, and other criteria, and combinations thereof. Examples of task rules:

(1) If Input Information=audio information only, then Task=transcribe the audio information;
(2) If Source of input information=User_A AND Input Information=one or more scanned images, then Task=convert text contents of each input image to typed text and convert graphics content of each image to computer drawings.
Task rules 130 are user-configurable. For example, APIs or GUIs provided by user interface subsystem 116 may be used by a task requester to customize task rules for the requester.

One of the functions of MMS 104 is to outsource the performance of the task while preserving the confidentiality and privacy of input information received for the task. As discussed above, one way of doing this is by dividing into task into microtasks, each microtask being associated with a subset of the input information, and then outsourcing the microtasks to multiple workers. By breaking up the task into microtasks, the input information is segmented into subsets, with each subset being input for a microtask allocated to a worker. In one embodiment, the segmentation of the input information into subsets to be associated with microtasks is performed by segmenter subsystem 118. Segmenter subsystem 118 is configured to segment the input information received for a task into one or more segments 136, each segment comprising a portion of the input information.

Segmenter subsystem 118 may use different types of segmentation techniques to segment the input information based upon the task to be performed and the constraints associated with the task. Examples of segmentation techniques that may be used include but are not restricted to various content-based segmentation techniques, temporal segmentation techniques for temporal data (e.g., video or audio), and others. Examples of content-based segmentation techniques that may be used include but are not restricted to word boundary segmentation, image/graphics based segmentation, character segmentation, character line segmentation, region segmentation, face segmentation, drawing regions segmentation, handwriting segmentation, object segmentation, signature segmentation, etc. If the input information comprises temporal information such as an audio clip or a video clip, then segmentation may be performed along the temporal dimension. For example, the audio and video clips may be segmented based on fixed time intervals. Content-based segmentation may also be performed on temporal input information. The segmentation techniques may be fully automated or may involve a combination of automated and manual input segmentation techniques. Further, there are different ways in which the input information may be segmented using a selected segmentation technique.

In one embodiment, segmenter subsystem 118 uses segmentation rules 132 to determine one or more segmentation techniques to be used for segmenting the input information for a task and also to determine the manner in which the input information is to be segmented using the selected one or more segmentation techniques. A segmentation rule may identify a condition and one or more segmentation techniques to be used and the manner in which the input information is to be segmented using the selected one or more segmentation techniques when the condition is met (or, alternatively, when the condition is not met). The condition for a segmentation rule may be based upon one or more criteria such as the task to be performed, the identity of the task requester, the type of information contained in the input information (e.g., audio information, video information, images, etc.), and other criteria, and combinations thereof. Examples of segmentation rules:

(1) If Input Information=audio information only, then Segmentation Technique=Temporal_Segmentation_Technique_A;
(2) If Task=Convert text to type text AND Input Information=Images, then Segmentation Technique=Word boundary segmentation.

In one embodiment, the acceptable risk level associated with a task may control how the task is to be broken into microtasks and how the input information is to be segmented into subsets. For example, the number of segments that the input information is segmented into may be inversely proportional to the risk threshold associated with the job. A low risk threshold may cause the input information to be segmented into X segments, a medium risk threshold may cause the input information to be segmented into Y segments, and a high risk threshold may cause the input information to be segmented into Z segments, where X>Y>Z. This correlation between the various risk thresholds and their corresponding number of segments may be encoded in segmentation rules 132 and used by segmenter 118 to perform the segmentation.

In certain embodiments, the desired quality level associated with a task may also be used to determine how the input received for the task is to be segmented into subsets, each subset being provided as input to a microtask. This correlation between the various quality thresholds and their corresponding number of segments may also be encoded in segmentation rules 132 and used by segmenter 118 to perform the segmentation.

Segmentation rules 132 are user-configurable. For example, APIs or GUIs provided by user interface subsystem 116 may enable a task requester to customize segmentation rules to suit the requester's needs. In one embodiment, different segmentation rules may be configured for different task requestors. For a particular task, segmenter subsystem 118 is configured to determine one or more segmentation rules to be used for the task and then based upon the selected segmentation rules determine the one or more segmentation techniques to be used and the manner in which the input information is to be segmented using the selected techniques. Segmenter subsystem 118 is then configured to segment the input information using the selected techniques in the manner specified by the selected segmentation rules. The segments 136 generated from performing the segmenting may then be provided by segmenter subsystem 118 to combiner subsystem 120 for further processing.

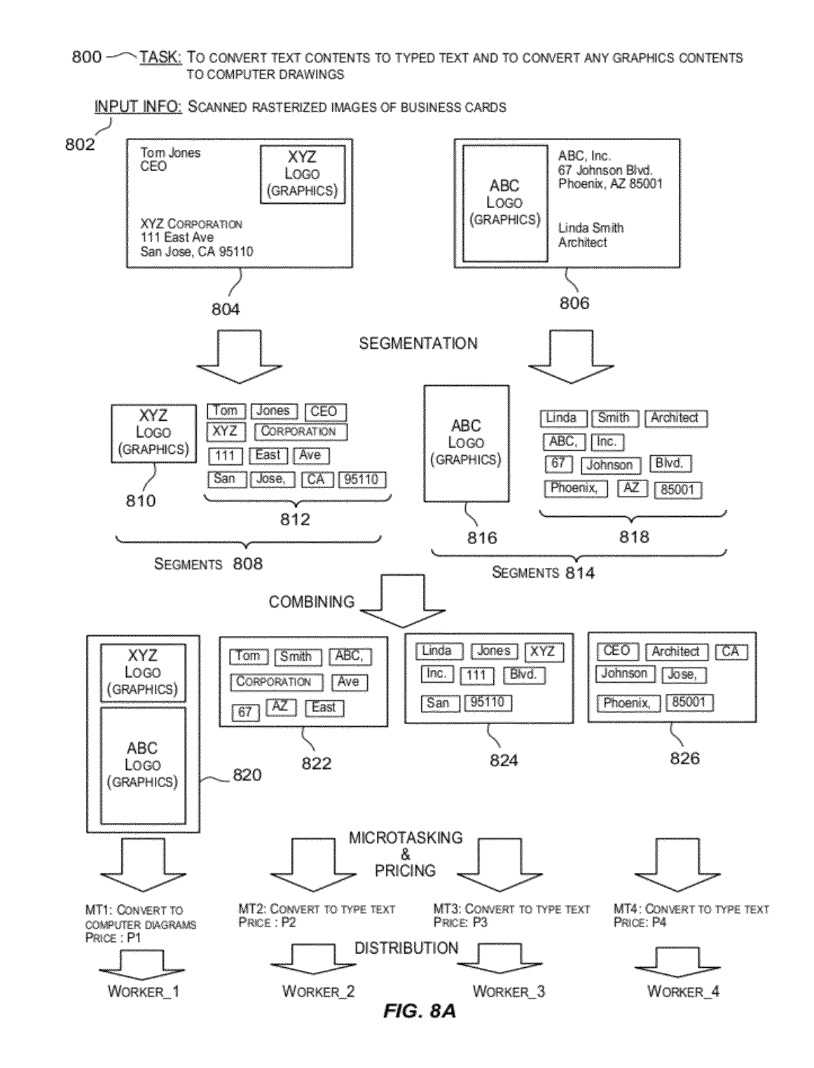

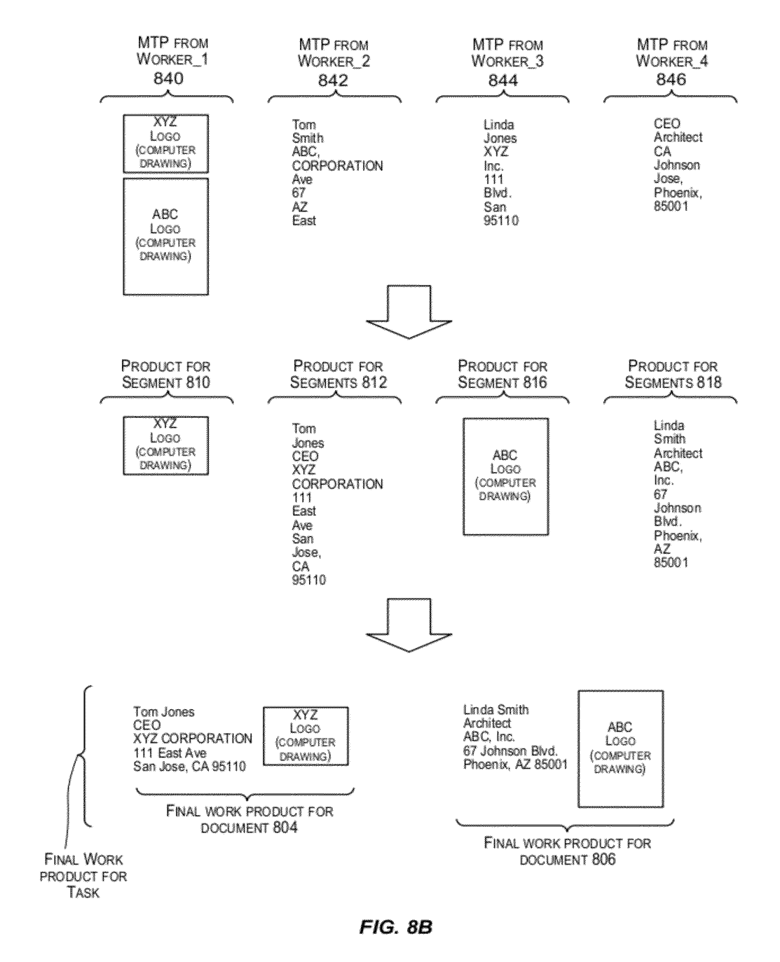

FIGS. 8A and 8B depict an example that will be used throughout this application to describe various aspects of an embodiment of the present invention. This example is however not intended to limit the scope of embodiments of the invention as recited in the claims. In the example depicted in FIG. 8A, a task request may be received comprising a task description 800 specifying that the task is to convert text contents of an image to type text and to convert any graphics contents of the image to computer drawings (e.g., VISIO drawings). Input information 802 received for such a task may comprise rasterized images of one or more business cards. The description 800 may include information specifying factors or constraints to be associated with the task such as the level of risk that can be taken with the supplied input information and/or the level of quality desired. In the example of FIG. 8A, the input information comprises two scanned images 804 and 806 of two business cards. In one embodiment, the scanned images may be included in the task request received by MMS 104 from a task requester system. In another embodiment, MMS 104 may provide a mechanism for generating the images. For example, MMS 104 may comprise a scanner that takes the business cards as input, scans the business cards to generate images 804 and 806, and then makes the images available for performing the task.

In the example of FIG. 8A, each input image is segmented using a word boundary segmentation technique and a graphics segmentation technique. The graphics segmentation technique determines the locations of graphics in each input image and creates segments comprising only the graphics portions. The word boundary segmentation technique determines word boundaries in each input image and creates segments corresponding to the word boundaries. In one embodiment, the word segmentation technique identifies a set of rectangles in each input document image that contain segmented word regions. Each segmented word region is then extracted from the input image and saved as a new image. These new images represent segments for the input image. As shown in FIG. 8A, image 804 is segmented into thirteen segments 808 including an image segment 810 and twelve word segments 812 based upon word boundaries. Image 806 is segmented into twelve segments 814 including an image segment 816 and eleven word segments 818 based upon word boundaries. Segments 808 and 814 may then be provided to combiner subsystem 120 for further processing. In one embodiment, techniques described in Berna Erol et al., “HOTPAPER: Multimedia Interaction with Paper using Mobile Phones,” ACM Multimedia Conference, 2008, Vancouver, British Columbia, Canada, pp. 399-408, may be used for performing the segmentation. The entire contents of the above-identified Berna Erol et al. publication are herein incorporated by reference for all purposes.

Since the manner in which segmenter subsystem 118 segments the input information may be different for different tasks, segmenter subsystem 118 stores segmentation information 134 for each task identifying the particular manner in which the input information was segmented for that task. In one embodiment, segmentation information 134 stored for a task may comprise: information identifying the task, information identifying the requester of the task, information identifying the input information received for the task, information identifying how the input information was segmented including the number of segments generated and the manner (e.g., the segmentation technique(s) that was used) in which the segments were generated, location of segments within the original input, and other information. Since the input information received for a task can comprise multiple input documents, segmentation information 134 may store information identifying the documents and for each document information identifying how the document contents were segmented. In this manner, given a segment, segmentation information 134 can be used to determine an input document corresponding to that segment, and also a task for which the input document was received as input. As is described below, segmentation information 134 is used by task product management subsystem (TPMS) 128 for constructing a final work product for a task.

The segmentation system may use the desired input risk and quality to determine how to segment the task. For example, if there is no risk requirement, all the text might remain in one segment; if there is a medium level of risk allowed then text could be segmented into different segments; if there is a very low risk allowed, then the input could be segmented into individual words (as shown in FIG. 8A); and for extremely low risk the input could be segmented into characters. The choice of segmentation may also take into account the desired quality level. In one case, leaving all the text in a single segment can lead to high quality because the same font might be used for all the text and information like a company name might appear multiple times, e.g., in both the address and the email address. Segmenting the text into words will typically lead to higher quality than segmentation into characters because both humans and machines benefit from recognizing characters in the context of words.

After the input information for a task has been segmented and segmentation information stored, segmenter subsystem 118 may provide segments 136 to combiner subsystem 120 for further processing. For example, segmenter subsystem 118 may provide segments 808 and 814 depicted in FIG. 8A to combiner subsystem 120 for further processing. In FIG. 8A, the word image segments are denoted by words within bounded boxes (this is to be differentiated from symbolic words in FIG. 8B corresponding to the word image segments—the symbolic words are shown without the bounded boxes).

Combiner subsystem 120 is configured to create combined segments 140 from segments 136. In one embodiment, the combining is done in a manner that seeks to reduce the risk of compromising the privacy of the contents of the input information received for the task. The manner in which the segments are combined may depend upon various factors including the acceptable risk and/or quality levels associated with the task to be performed. There are different ways in which contents of segments 136 may be combined by combiner subsystem 120 so as to preserve the privacy of the contents of the input information (or in other words, to reduce the risk associated with loss of privacy or confidentiality of the input information as a result of the outsourcing). In one embodiment, this combination is done with a view towards obfuscating the contextual relationships between pieces of information in the input information (example provided below). In another embodiment, “noise” information may be combined along with contents of the input information. For example, fake names, phone numbers, etc. may be added to the contents extracted from the input information. The combiner may make an estimate of the risk associated with different combination rules, and compare that with the level of risk specified for the task.

In one embodiment, combiner subsystem 120 uses combination rules 138 to determine how the combination is to take place. A combination rule may identify a condition and one or more combination techniques to be used when the condition is met (or, alternatively, when the condition is not met). The condition for a combination rule may be based upon one or more criteria. The following Table A lists example criteria that may impact the manner in which combination is performed by combiner subsystem 120 and the impact of each criterion on the combination processing.

TABLE A

| Criterion | Impact on Combination Processing |
|---|---|
| Privacy | The combined segments may be formed in a |
| considerations | manner that causes the private information to |
| | be scrambled across separate combined |
| | segments such that the contents of any |
| | individual combined segment would not |
| | compromise the privacy of the overall input |
| | information. |
| | For example, if certain portions of the input |
| | information have been tagged as private (e.g., |
| | as described earlier, a task requester may |
| | specify certain portions of the input |
| | information as being private), combiner |
| | subsystem 120 may take this into consideration |
| | when generating combined segments. In one |
| | embodiment, the combined segments may be |
| | formed in such a way that the input |
| | information contents tagged as private are |
| | distributed across multiple combined segments |
| | such that knowing the contents of a single |
| | combined segment would not compromise the |
| | privacy of the input information. |
| Source of the task | A task requester may be allowed to specify a |
| request or input | customized combining technique to be used for |
| information | tasks originating from the task requester. |
| The type of contents | A particular combination technique may be |
| included in the input | well suited for information of a certain type but |
| information | not suited for information of another type. |
| Pricing information | The pricing information may impact the |
| associated with | number of combined segments to be created |
| the task | and the contents of the combined segments |
| | such that the overall cost for completing the |
| | task is within acceptable pricing limits |
| | specified for the task. |
| | As described below, one or more microtasks |
| | are determined for each combined segment. A |
| | price may then be determined for completing |
| | each microtask. Accordingly, the number of |
| | combined segments impacts the number of |
| | microtasks, which in turn impacts the overall |
| | cost of completing the task. In some instances, |
| | increases in the number of combined segments |
| | and thus the number of microtasks beyond a |
| | certain threshold may cause costs for |
| | performing the task to exceed the acceptable |
| | pricing costs. |
| Desired time to | The time to completion for a task may impact |
| completion for | the number of combined segments to be |
| the task | created and the contents of the combined |
| | segments. The number of combined segments |
| | impacts the number of microtasks for the task, |
| | which in turn may impact the time needed to |
| | perform the microtasks. In some instances, |
| | creating a large number of combined segments |
| | each with smaller content may make the |
| | overall task to be completed faster, but in other |
| | instances this may add delay to the overall task |
| | completion. |
| Availability | As described above, the number of combined |
| of workers | segments affects the number of microtasks. |
| | The microtasks are then outsourced to workers |
| | for completion. Accordingly, the number of |
| | microtasks affects the number of workers |
| | needed to perform the microtasks. |
| | Accordingly, the number of combined |
| | segments may be determined based upon the |
| | availability of workers. |
| Skill levels | For workers with a known skill set, the |
| of workers | combined segments may be created such that |
| | the microtasks associated with the combined |
| | segments can be performed by those workers. |
| Human/automated | In one embodiment, content related to tasks |
| | that need to be performed by humans may be |
| | grouped into one set of combined segments |
| | while tasks that can be performed by |
| | computers may be grouped into a separate set |
| | of combined segments. In this manner, the |
| | overall task can be performed using a hybrid of |
| | human workers and automated computer |
| | techniques. |
| Desired degree | The desired degree of accuracy for the task |
| of accuracy | may impact the number of combined segments |
| for the task | that are created and the contents of the |
| | combined segments. |

The manner in which the segments are combined may depend upon the acceptable risk level and/or quality level associated with the task. This correlation between the various risk and/or quality thresholds and combination techniques to be used may be encoded in combination rules 138 and used by combiner 120 to perform the combination.

Referring to the example depicted in FIG. 8A, four combined segments 820, 822, 824, and 826 have been created based upon the contents of segments 808 and 814. The contents of segments 810 and 816 (comprising graphics) have been combined into a single combined segment 820. Combined segments 822, 824, and 826 have been created based upon word segments in 812 and 818 extracted from the input images. For example, each of segments 822, 824, and 826 is created by combining or fusing one or more of the segment images from 812 and 818 to create a new combined image (e.g., 822) comprising one or more segment images.

A combined image may comprise segment images from multiple different documents. For example, combined segment 822 comprises a segment “Tom” extracted from document 804 and also includes a segment “Smith” extracted from document 806. Similarly, combined segment 820 comprises a segment 810 from document 804 and a segment 816 from document 806. Similarly, combined segments 824 and 826 also comprise contents from both documents 804 and 806. In alternative embodiments (not depicted in FIG. 8A), a combined segment may also include noise content that is introduced on purpose.

As can be seen in FIG. 8A, the segments have been combined in such a way that portions of the input information tagged as private by the task requester (e.g., name of person, the position of the person, the employer of the person, and the address of the employer) are spread across the three combined segments 822, 824, and 826. As a result, each combined segment contains less than all the information from any one input document. For example, even though the word “Tom” from input document 804 is included in combined segment 822, Tom's last name “Jones” is not included. It is not possible for anyone looking at the contents of combined segment 822 to determine the name Tom Jones thereby preserving the privacy of the name. This lowers the estimated risk for each of the initial tasks. Thus if there was a risk of 0.05 of a release of a full name from a single business card, the risk of the system disclosing a full name when all the first names and last names are separated might be estimated to be 1000 times lower, or 0.00005. These estimations may be based on empirical results.

A further level of privacy protection is enabled by the manner in which the individual segments extracted from the input documents are combined to form a combined segment. For example, combined segment 822 comprises a segment containing first name “Tom” from document 804 and last name “Smith” from input document 806. Such scrambling of segments adds another layer of obfuscation and additional protection for the information whose privacy is to be preserved since it is very difficult, if not impossible, to ascertain the actual information from just one of the combined segments.

As is evident from the example depicted in FIG. 8A, a combined segment can comprise segments extracted from multiple input documents. For example, combined segment 822 comprises a segment “Tom” from image 804 and a segment “Smith” from image 806. Accordingly, contents from two or more different input documents may be combined into a single combined segment. This scrambling of contents across multiple input documents further reduces the probability that the privacy of content from any one document will be compromised.

Since combiner subsystem 120 may use different combination techniques for different tasks, combiner subsystem 120 stores combination information 142 for each task identifying the particular manner in which segments have been combined for that task to create the combined segments. In one embodiment, combination information 142 stored for a task may comprise the following information stored for each combined segment: information identifying the combined segment, information providing a mapping between the combined segment and segments included in the combined segment, location of the segments within the combined section, and other information. Accordingly, given a combined segment, combination information 142 may be used to determine one or more segments whose contents are included in the combined segment. As described below, combination information 142 is used by TPMS 128 for constructing a final work product for the task based upon results received from performance of microtasks associated with the combined segments.

After the combined segments have been created and combination information 142 stored, combiner subsystem 120 may forward combined segments 140 to microtask generator subsystem 122 for further processing. For example, combiner subsystem 120 may provide combined segments 820, 822, 824, and 826 depicted in FIG. 8A to microtask generator subsystem 122 for further processing.

Microtask generator subsystem 122 is configured to determine one or more microtasks for each combined segment. In one embodiment, microtask generator subsystem 122 may use microtask rules 144 to determine the one or more microtasks for a combined segment. A microtask rule may identify a condition and one or more microtasks to be associated with a combined segment when the condition is met (or, alternatively, when the condition is not met). The condition for a microtask rule may be based upon one or more criteria such as the task to be performed, the contents of the combined segment, the identity of the task requester, and other criteria.

Referring to the example depicted in FIG. 8A, four microtasks have been determined, one for each combined segment: (1) Microtask “MT1: Covert to computer diagrams” is associated with combined segment 820; (2) Microtask “MT2: convert to type text” is associated with combined segment 822; (3) Microtask “MT3: convert to type text” is associated with combined segment 824; and (4) Microtask “MT4: convert to type text” is associated with combined segment 826. Although only one microtask is associated with each combined segment in the example depicted in FIG. 8A, in alternative embodiments multiple microtasks may be associated with a single combined segment.

Referring back to FIG. 1, once microtasks for a set of combined segments have been determined, microtask generator subsystem 122 may use the services of pricing subsystem 124 to determine prices for the generated microtasks. HITs are typically priced at a higher price point per unit time than tasks that are performed by a computer or machine. Pricing subsystem 124 may be configured to compute a price point for a microtask based upon various criteria such as the amount of content in the input for the microtask. For example, a microtask may be priced based upon the amount of contents in the combined segment corresponding to the microtask. In other embodiments, microtasks that can be performed by a computer may be differentiated from microtasks that can be performed by a human. For example, preprocessor 126 may be used to differentiate between microtasks to be performed by a machine versus microtasks to be performed by a human prior to pricing of the microtasks. In one embodiment, preprocessor subsystem 126 may also be used to preprocess contents of a combined segment to put them in a form that is more conducive for performing the microtask(s) associated with that combined segment. Further details related to pricing of microtasks and use of preprocessor subsystem 126 are provided below. Referring to the example depicted in FIG. 8A, price P1 is determined for microtask MT1, price P2 is determined for microtask MT2, price P3 is determined for microtask MT3, and price P4 is determined for microtask MT4.

Microtask generator subsystem 122 is configured to forward the microtasks and associated information to distribution system 106 for distribution to one or more providers 114. Microtask generator subsystem 122 may also store microtask information 146 regarding the microtasks that have been forwarded to distribution system 106. For a microtask, microtask information 146 may include information identifying the microtask, pricing information associated for the microtask, information mapping the microtask to its input combined segments, the distribution system to which the microtask is forwarded (especially in embodiments where MMS 104 may use multiple distribution systems), and other information.

As described above, microtask generator subsystem 122 is configured to forward the microtasks and associated information to distribution system 106 for distribution to one or more providers 114. The information associated with a microtask may include a combined segment whose contents are to be used as input for performing the microtask, pricing information for the microtask, and other information.

The information associated with a microtask may also include context information, which may provide a context for the performance of the microtask. This context information may be provided to a provider to help with the performance of the microtask. For example, for a microtask that involves converting word images to text type, in order to increase the accuracy of the microtask, context information may be provided for the microtask that indicates that the input word images have been extracted from a medical form or a business card. As another example, the context information for a microtask may provide further information related to the microtask such as that the workers need to type in numbers, email addresses, etc. The context information, which is forwarded to a provider along with the microtask, thus may include information that provides a context for performing the microtask.

In one embodiment, MMS 104 may be configured to determine one or more constraints 150 to be associated with the set of microtasks. Constraints 150 may include constraints related to individual microtasks and/or constraints related to how the microtasks are to be distributed. Constraints may include constraints related to how the microtask is to be performed, characteristics of a worker allowed to perform the microtask, time to completion expectations for the microtask, where the microtask can be performed (e.g., location constraints), desired accuracy for the microtask, distribution constraints, and the like. Constraints related to the characteristics of the worker may include, for example, whether the microtask is to be performed by a machine or a human worker, level of expertise of the worker, location of the worker (e.g., within the US or outside), age of the worker, and the like.

The acceptable risk and or quality level associated with a task may control the constraints that are associated with the microtasks generated by microtask generator subsystem 122. For example, in order to lower the risk within acceptable limits, it may be better to outsource a particular microtask (or set of microtasks) to one or more machine workers instead of a human worker. On the other hand, in order to get output of a desirable quality, it may be better to outsource a particular microtask (or the set of microtasks) to one or more human workers. Accordingly, constraints 150 may specify whether a particular microtask is to be distributed to only a human provider, only a machine provider, or could be sourced to either a human or machine provider based upon risk and quality levels associated with the task. These correlations between risk and/or quality factors and microtask constraints may be encoded in microtask rules information 144 and used by microtask generator subsystem 122 in determining the set of microtasks corresponding to the requested task and constraints, if any, to be associated with the set of microtasks.

Constraints 150 may also include distribution constraints related to the manner in which distribution system 106 distributes or outsources the set of microtasks to individual providers. For example, a distribution constraint for a set of microtasks may specify that a provider cannot be allocated more than one microtask from the set of microtasks. Such a constraint essentially ensures that a provider can only be allocated one microtask from the set of microtasks. This is important for protection of privacy since this ensures that a provider has exposure to at most one combined segment corresponding to that one microtask, thereby ensuring that only a subset of the input information received for the task is exposed to the provider.

Distribution constraints 150 may also include other constraints such as constraints that impose geographical constraints on the microtasks outsourcing. For example, a distribution constraint for a set of microtasks may specify that no two microtasks from the set of microtasks should be allocated to providers within the same city. This adds geographical distance between the providers thereby further reducing the chance of the privacy of the input information being compromised. Such distribution constraints further reduce (or almost eliminate) the risk that privacy of the contents of the input information will be compromised.

In some instances, one or more portions of input information for a microtask may be redacted (e.g., blacked out) for preserving the privacy of the information. The regions to be redacted may be marked manually by a human operator of MMS 104 based upon information received from a task requester. Alternatively, the sections to be redacted may be determined automatically, for example by using optical character recognition (OCR) techniques, keyword searches (such as for social security number identified as being private by the task requester), and the like.

Distribution system 106 is configured to receive a set of microtasks from MMS 104 (and associated constraints, if any), determine one or more workers or providers for performing the microtasks, and to distribute the microtasks to the determined providers. The term outsourcing is commonly used to refer to the distribution of tasks to one or more providers. The providers may include human workers and/or automated computer systems (e.g., system 110 depicted in FIG. 1). In some embodiments, distribution system 106 may forward a microtask and associated information to a system 108 (e.g., a computer) used by a worker or provider. The information associated with a microtask that is provided to a provider may include contents of one or more combined segments that are to be used as input for performing the microtask, possibly pricing information determined for the microtask, expected quality information for the microtask, a timeframe for completing the microtask, and other information.

Different techniques may be used to deliver a microtask and its associated information to a provider. In some cases, the microtask and associated information may be provided to a system of a human worker selected for performing the microtask or to a system/machine that is to perform the microtask. For example, an email may be sent to a provider identifying the microtask to be performed and the input information for the microtask (i.e., the combined segment for the microtask) may be attached to the email. In other embodiments, the information may be provided directly to a human worker. In one embodiment, distribution system 106 may use distribution rules 148 to facilitate the distribution process. In one embodiment, a distribution system such as Amazon Mechanical Turk may be enhanced to provide functionality provided by distribution system 106.

Distribution system 106 is configured to ensure that the microtasks are distributed in conformance with any constraints associated with the microtasks. In particular, the desired risk or quality can be used to impact the distribution of microtasks. As a result of such constraints, microtasks from a set of microtasks may be outsourced or distributed to different geographic locations, workers with different IDs, workers in different age groups, workers in different time zones, workers who work for different outsourcing companies, etc.

Distribution system 106 may use different techniques to select one or more providers 114 for the microtasks to be performed. In one embodiment, a bidding system may be used in which a microtask is distributed to a provider with the lowest bid. In one embodiment, additional measures may be taken to protect the privacy of the information in a bidding system. For example, for a particular microtask, distribution system 106 may automatically produce a “representative” microtask (i.e., a microtask of the same difficulty as the target particular microtask but with fictitious input contents, e.g., same length of word for a conversion to type text, same classifier confidence, etc.) to get bids from providers. Distribution system 106 may then select a specific provider based upon the bids and then distribute the actual particular microtask and its associated input combined segment(s) to the “winning” bidder. Using such a technique, only one selected provider has access to a microtask and its associated input content. This enhances the security of the distribution process. The process of providing a representative microtask and selecting a provider based upon bids for the representative problem may be automated or may involve some human input.

In another embodiment, instead of using a bidding system, potential providers may be asked to solve a representative microtask and only one provider who is able to solve the problem, or solve the problem within a desired timeframe with a desired quality, is allowed to gain access to the actual microtask(s) to be performed, while locking out others. Such an approach also enhances security or reduces the risk and enhances tracking since the identity of the provider is known. In such a scenario, if the contents associated with a microtask are publicly revealed (or compromised), the identity of the provider who leaked the information can be easily determined.

It may be possible that a worker to whom a microtask is distributed does not accept the microtask. For example, the worker may not accept cost/price constraints associated with the microtask. In another scenario, it may not be possible to even find a worker for a microtask. For example, if there are worker-related, geography-related, etc. constraints associated with a microtask it may not always be possible to find a worker that satisfies the constraints. As a result the microtask may sit undistributed. To cover for such scenarios, a timeout value may be associated with each microtask. If a microtask cannot be outsourced (which may be due to rejection of the microtask by a worker, an appropriate worker cannot be found, or other reasons) within the timeout value associated with the microtask, various actions related to the microtask may be triggered upon expiration of the timeout. In one embodiment, upon a timeout, if it is determined that the task has been rejected by a worker, then the microtask may be outsourced to a different worker, or alternatively, the microtask may be again distributed to the same worker but now with modified constraints (e.g., with a higher cost/price constraint) making it more likely that the worker will accept the microtask. In a scenario where the timeout has occurred because a worker could not be found for the microtask, constraints associated with the microtask may be changed (typically lowered) to enable the task to be distributed to a larger and more available set of workers. In this manner, upon a timeout associated with a microtask, various actions may be performed to redistribute the microtask.

Distribution system 106 is also configured to receive the results or work products of performing the microtasks (referred to as microtask products) from providers 114. The microtask products may be received from one or more worker systems 108 and/or from one or more automated systems 110. Distribution system 106 is configured to forward the microtask products to MMS 104. In some embodiments, one or more providers may directly provide the microtask products to MMS 104.

In one embodiment, distribution system 106 may poll systems of providers 114 to receive the microtask products. In an alternative embodiment, a provider system may be configured to push microtask products to distribution system 106. Further, in one embodiment, MMS 104 may poll distribution system 106 to receive the microtask products while in other embodiments distribution system 106 may be configured to push microtask products to MMS 104.

Microtask products received by MMS 104 from one or more distribution systems 106 are forwarded to task product management subsystem 128 (TPMS). TPMS 128 is configured to construct a final work product for the task based upon the microtask products received for microtasks corresponding to the task. In one embodiment, the final product for the task may be generated by aggregating the microtask work products received for the microtasks. TPMS 128 may comprise an assembler module 129 to perform the aggregation. The final product may then be provided to the task requester.

In one embodiment, TPMS 128 uses microtask information 146, combination information 142, and segmentation information 134 to construct the final work product for a task based upon the microtask products received for microtasks corresponding to the task. For example, for a microtask product received from distribution system 106, TPMS 128 may use microtask information 146 to determine a microtask corresponding to the microtask product and a combined segment corresponding to that microtask (i.e., a combined segment that was used as input for the microtask). In this manner, TPMS may use microtask information 146 to map each received microtask product to a combined segment (or combined segments). TPMS 128 may then generate a work product for each combined segment based upon the one or more microtask products mapped to the combined segment. TPMS 128 may then use combination information 142 to determine the segments corresponding to the combined segments. TPMS 128 may then construct work products for each segment based upon the work products for combined segments corresponding to the segment. TPMS 104 may then use segmentation information 134 to map the segments to individual input documents in the input information received for the task. TPMS 128 may use segmentation information 134 to construct a work product for each input document based upon the work products constructed for the segments. The work products constructed for the input documents may represent the final work product for the task.

As previously discussed, the work product or output for one microtask (or a portion thereof) may be used as input information for another microtask. For example, the work product generated by a machine performing a first microtask may be used as input for a second microtask to be performed by a human worker. Accordingly, it is possible to submit a first microtask task to one “worker,” receive results obtained from performing the microtask, and create a new microtask whose input is the results received (or a portion thereof) from performing the first microtask. In one embodiment, the results received from the first microtask may be combined with other information (e.g., the results received from another microtask) and the combined information used as input for a new microtask that is sourced to another worker or to an automated system. In another embodiment, the results received from a first microtask may be segmented into subsets, a new microtask determined for each subset, and the new set of microtasks may then be sent to workers to be performed.

Accordingly, in certain instances, TPMS 128 may forward one or more of the received microtask products to microtask generator subsystem 122. Upon receiving a microtask product from TPMS 128, microtask generator subsystem 122 may generate a new set of one or more microtasks where the received microtask product is input for the new microtasks. These new microtasks may then be priced using pricing subsystem 124 and then sent to distribution system 106 for distribution to one or more providers.

In one embodiment, the quality of the microtask product received from a provider for a microtask may be checked and if determined not to meet a requisite quality threshold, the microtask may be resubmitted to distribution system 106 for distribution to another provider. For example, TPMS 128 may receive a microtask product resulting from transcription of an audio segment. TPMS 128 may then determine a confidence score associated with the microtask product. If the confidence score is below some user-configurable threshold, TPMS 128 may determine that the transcription needs to be redone and may send the microtask product to microtask generator subsystem 122. Microtask generator subsystem 122 may then determine the combined segment (comprising the audio information) corresponding to the microtask product and generate a new transcription microtask for the combined segment. The new microtask may then be sent to distribution system 106 for distribution to a provider other than the one who performed the microtask the first time.

FIG. 8B shows an example of how a final work product may be constructed for the task received in FIG. 8A based upon microtask products received corresponding to the microtasks generated in FIG. 8A and distributed to multiple providers. As depicted in FIG. 8B, microtask products (MTPs) corresponding to the microtasks MT1, MT2, MT3, and MT4 may be received by MMS 104. Microtask product 840 corresponding to microtask MT1 is received from Worker_1 and comprises computer drawings corresponding to the graphics included in combined segment 820. Microtask product 842 corresponding to microtask MT2 is received from Worker_2 and comprises type text corresponding to the contents of the various segments included in combined segment 822. Microtask product 844 corresponding to microtask MT3 is received from Worker_3 and comprises type text corresponding to the contents of the various segments included in combined segment 824. Microtask product 846 corresponding to microtask MT4 is received from Worker_4 and comprises type text corresponding to the contents of the various segments included in combined segment 826.

In one embodiment, each received microtask product may have a quality estimate associated with it, Q1, Q2, Q3, Q4 depending on the worker used, and the sequence of corrections, or checks performed on the microtask. This quality is the estimated closeness to the desired result for the microtask rather than the quality of the recognized card.

Using microtask information 146 and combination information 142, TPMS 128 may then map the microtask products to their corresponding combined segments and eventually to segments 808 and 814. As depicted in FIG. 8B, a portion of the contents (computer drawing of XYZ logo) of microtask product 840 is mapped to segment 810—this represents the product for segment 810. A portion of the contents (computer drawing of ABC logo) of microtask product 840 are mapped to segment 816—this represents the product for segment 816. In a similar manner, the products for segments in 812 and 818 are determined from the contents of microtask products 842, 844, and 846. The product for each of the segments in 812, 816, and 818 comprises a list of type text portions corresponding to the segment contents.

TPMS 128 then maps the segments to individual input documents 804 and 806 in the input information received for the task and constructs work products for the input documents. TPMS 128 may use segmentation information 134 to map segments to the individual input documents for a task. As depicted in FIG. 8B, the final work product for document 804 comprises type text corresponding to the text portions in document 804 and a computer drawing corresponding to the XYZ logo graphic in document 804. The final work product for document 806 comprises type text corresponding to the text portions in document 806 and a computer drawing corresponding to the ABC logo graphic in document 806. The final work product for task 800 thus comprises work products constructed for each input document received as part of the input information for the task.

In one embodiment, a quality estimate may be provided for the final work product. This quality estimate will depend on the quality estimates associated with the individual microtask products. In the simplest case the quality estimate for the final work product might be an average of the quality estimates associated with the microtask work products that were aggregated to form the final work product. Alternatively, the quality estimate might be weighted depending on the number of items in the final work product that were part of each microtask.

Referring back to FIG. 1, upon constructing the final work product for the task, TPMS 128 may be configured to forward the final work product to the task requester. The final work product may be forwarded to the task requester using several different ways. In one embodiment, the work product may be stored in a memory location designated by the task requester for storing the final work product. The final work product may also be communicated to the task requester. For example, the final work product depicted in FIG. 8B may be written to a WORD document, and the WORD document may then be communicated to the task requester. Other user-configurable actions may also be performed on the final work product by MMS 104.

In one embodiment, the set of microtasks determined by microtask generator subsystem 122 may include duplicated microtasks. For example, for a combined segment comprising audio information to be transcribed, in order to increase the accuracy of the transcription, multiple duplicate microtasks may be created associated with the same combined segment, each specifying that the audio information is to be transcribed. A constraint may be associated with the multiple duplicate microtasks that they be distributed to different providers. MMS 104 may then compare the microtask products received corresponding to the duplicate microtasks from the different providers to determine the accuracy of the transcription.

In another scenario, a microtask and associated input information may be outsourced to the same provider multiple times such that the microtask is performed multiple times. Microtask products resulting from the microtask being performed multiple times may increase the quality of the resultant work product.

There are many tasks that computers do well most (e.g., 90%) of the time, but fail badly the rest of the time. This quality level is often not good enough and conventionally these tasks are given to humans. In such a scenario, MMS 104 may generate a first set of microtasks for performance by a computer system. Based upon the results obtained for the first set of microtasks, MMS 104 may generate a second set of microtasks that are distributed to human workers, wherein the results obtained from performance of the first set of microtasks are used as input to the second set of microtasks. The second set of microtasks may involve correcting errors in results obtained from the first set of microtasks. In this manner, humans may be used to correct the mistakes made by an otherwise automated process. The quality of the overall task, and the estimate of that quality, is a complex combination of the quality of the work done by humans and done by machines.

In another embodiment, two sets of microtasks may be generated for a task, a first set more suitable for performance by machines and a second set more suitable for performance by humans. A combination of human-performed microtasks and computer-performed microtasks may thus be used to efficiently solve a task in a semi-automated manner. This hybrid model offers several benefits. For example, humans can provide training data for the automated parts of the process, which can enable computers to make fewer mistakes. Further, microtasks that have a higher cognitive requirement may be outsourced to humans while the more mundane microtasks are outsourced to machines/computers. This makes it more interesting for the human worker (which may lead to better quality), while requiring less overall human time to complete the overall task. This may also make the overall task less expensive since costs associated with microtasks performed by a machine are generally cheaper than microtasks performed by a human.

Quality control is quite important in any outsourcing model. Providers, especially human workers, need to be evaluated and provided feedback on the quality of their work. Traditionally, this is done by humans who review the output of a task (e.g., a microtask) and provide feedback. This process may, however, be as expensive as the task itself, especially when the task is broken into multiple smaller microtasks, each of which needs to be evaluated separately. In one embodiment, MMS 104 is configured to automate the quality control for a task by casting quality control as a microtask that can itself be micro-outsourced (and thus broken into smaller jobs, some performed by humans and some by computers). There are several ways to increase the quality in the generation of microtasks. One way is having multiple workers perform the same task and accept the result only when two workers agree—this increases the quality, Q(I,W₁,W₂)>Q(I,W). Such a technique may be more expensive as it requires multiple workers to do the entire task.

According to another technique, some subset of the input can be sent to multiple workers with some overlap, for example if I=I₁+I₂+I₃ then W₁ can work on I₁ and I₂, W₂ can work on I₂ and I₃, and W₃ can work on I₃ and I₁, thus no worker sees the whole input, reducing risk, and yet each input is processed by more than one worker. In one embodiment, quality control can be integrated with the task by generating a microtask related to quality-related actions. For example consider a task consisting of recognizing numerical entries in a form where the total amount is also written and is to be recognized, and where the summation of individual amounts transcribed should add up to the transcription of the total amount. The transcribed amounts can be easily summed by an automated task and if the commuted sum matches the transcribed sum, the quality of the transcribing can be considered to be good. If the amounts do not match, an additional microtask may be necessary to check quality, for example by having a worker verify that the original form total was computed correctly, or by repeating some of the tasks with different workers.

Another approach to improving quality, as well as making the performance of the microtasks more interesting, involves publishing worker performance in some format. For example, feedback from work providers can be used to establish some score and top scoring workers can be published on “high score” lists as is done currently with games and social networks. In addition to work provider feedback, workers could be recognized for the speed of task completion or the variety of tasks performed. Bonuses might be awarded to top workers in some quality measure.

Another approach to quality control involves self reported quality. Often a human worker is capable of accurately reporting the confidence in the results of the microtask performed by the worker. For example, for a transcription microtask, a human worker performing the microtask may be provided by the ability to provide feedback (e.g., a confidence score) on the performance of the microtask. This feedback may be used by MMS 104 in determining whether the microtask needs to be redone. A worker's estimate of the quality Q_{worker}(I), can be compared to a desired quality level and if the desired quality has been achieved the task can be considered complete. If the desired quality has not been achieved a correction microtask might be used to improve the quality, or the work might be repeated by another worker using another microtask, or combined with the output from another worker. Workers may be able to report an interest in getting more jobs of a certain kind, or in getting additional training on some jobs or types of jobs. This may allow the work provider to provide additional instructions and improve the quality. Reports from workers about confidence in their work along with automatic statistics can be used to estimate job quality for particular jobs, and to determine the assignment of new tasks.

Although MMS 104 is shown as a single system in the embodiment depicted in FIG. 1, in alternative embodiments, the functions performed by MMS 104 may be performed by multiple systems collaborating with each other. Further, while MMS 104 and distribution system 106 are shown as separate systems in FIG. 1, in alternative embodiments, the functions performed by MMS 104 and distribution system 106 may be performed by a single system or multiple systems. Accordingly, the embodiment depicted in FIG. 1 is not intended to limit the scope of the present invention as recited in the claims. Other variations are possible.

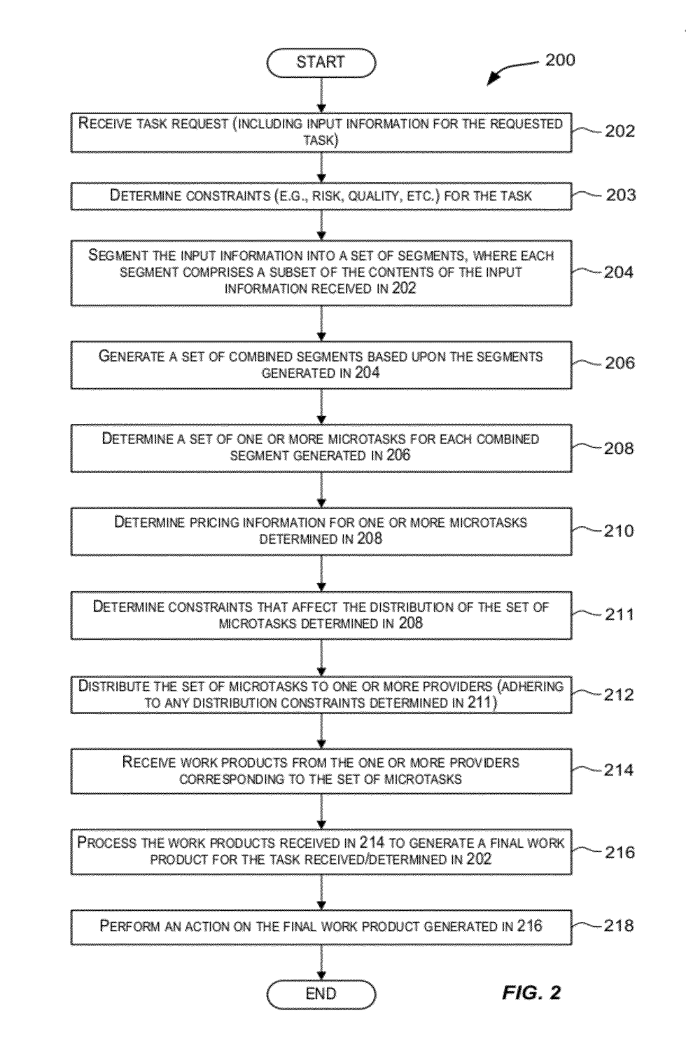

FIG. 2 depicts a simplified flowchart 200 describing a high-level method for performing a task while preserving the privacy of the contents of input information received for the task according to an embodiment of the present invention. The processing depicted in FIG. 2 may be performed by software (e.g., program, code, instructions) executed by a processor, by hardware, or combinations thereof. The software may be stored on a computer readable storage medium. The particular series of processing steps depicted in FIG. 2 is not intended to limit the scope of embodiments of the present invention as recited in the claims.

As depicted in FIG. 2, processing may be initiated upon receiving a task request (step 202). The task request may identify the task to be performed and may also specify input information to be used for performing the task. In alternative embodiments, the task request may comprise input information and MMS 104 may automatically determine the task to be performed based upon attributes of the input information. For example, MMS 104 may use task rules 130 to determine the task to be performed. The information received in 202 may also include one or more factors or constraints for the task to be performed such as an acceptable risk level, a desired quality level, a cost threshold, and the like.

Factors or constraints for the task are determined (step 203). One or more of these factors may be specified in the task request received in 202. For example, a task requester may specify one or more of an acceptable risk threshold for the task, an expected quality threshold for the task, a cost for performing the task, etc. via the task request. In one embodiment, MMS 104 may be configured to determine factors, if any, for the task based upon an analysis of the task request. For example, based upon the nature of the task to be performed and/or based upon characteristics of the input information provided for the task, MMS 104 may determine a set of one or more factors or constraints to be associated with the task. In yet another scenario, some default constraints configured for MMS 104 may be determined and used for the requested task. The factors or constraints determined for the task in 203 may impact how the task request is processed. For example, the various processing described below with respect to 204, 206, 208, 210, 211, 212, 214, 216, and 218 may be performed such that the constraints determined in 203 are met or satisfied.

The input information is then segmented into a set of segments, where each segment comprises a portion or subset of the contents of the input information received in 202 (step 204). The segmentation may be performed based upon a set of segmentation rules selected for the task. Constraints associated with the task to be performed such as an acceptable risk level, a desired quality level, a cost threshold, and the like may impact the segmentation. In the embodiment depicted in FIG. 1, processing in 204 may be performed by segmenter subsystem 118.

A set of combined segments may then be generated based upon the segments created in 204 (step 206). A combined segment created in 206 may include one or more of the segments created in 204 or portions thereof. Constraints associated with the task to be performed such as an acceptable risk level, a desired quality level, a cost threshold, and the like may impact the manner in which the segments are combined. For example, as described earlier for FIG. 1, the information may be distributed across multiple combined segments such that the information corresponding to any one combined segment does not compromise the contents of the overall input information. In the embodiment depicted in FIG. 1, processing in 206 may be performed by combiner subsystem 120.

In one embodiment, generation of the set of combined segments may not be performed every time. In such an embodiment, whether or not combined segments are generated may depend upon the risk level associated with the task to be performed. Generation of combined segments further obfuscates the input information over and beyond segmentation and thus helps to reduce the risk associated with the outsourcing. Accordingly, in one embodiment, the combined segments may be generated only when the risk level associated with the task is below some threshold. For example, the combination may not be performed if the acceptable risk level associated with the task is “high” but may be performed if the risk level is “medium” or “low”. Further, the type of combination techniques that are used may also differ for various different risk levels. For example, for a particular acceptable risk level, the generation of a combined segment may involve combining multiple segments generated in 204. However, for a lower acceptable risk level, in addition to combining multiple segments (or instead of combining multiple segments), the generation of the combined segment may also include adding noise information to the combined segment. In this manner, the risk level associated with a task may determine if and how the combined segments are generated. Information related to a risk level threshold for generating combined segments and also the various combination techniques to be used corresponding to the various risk levels may be encoded in combination rules 138 that are used by combiner 120 for generating the combined segments.

One or more tasks (microtasks) are then determined for each of the combined segments created in 206 (step 208). In the embodiment depicted in FIG. 1, processing in 208 may be performed by microtask generator subsystem 122.

Pricing information may be determined for one or more of the microtasks determined in 208 (step 210). In the embodiment depicted in FIG. 1, processing in 210 may be performed by pricing subsystem 124. Further constraints, if any, that affect the distribution of the set of microtasks determined in 208 may be determined (step 211). These constraints may include constraints related to individual microtasks in the set of microtasks determined in 208 and/or constraints applicable to the set of microtasks.

The set of microtasks may then be distributed (outsourced) to one or more providers (step 212). Information associated with a microtask may also be distributed as part of 212. Information associated with a microtask may include a combined segment that contains information to be used as input for the microtask and pricing information associated with the microtask. In some embodiments, tools/resources for facilitating the performance of the microtask may also be distributed along with the microtask. For example, if the microtask involves converting graphics to computer drawings, a computer drawing application (e.g., VISIO) may be distributed along with the microtask. The distribution in 212 may be performed while conforming to any constraints associated with the microtasks and determined in 211. The providers may be human workers or automated systems.

Upon performance of the microtasks, work products corresponding to the microtasks may be received (step 214). A final work product for the task received in 202 may then be constructed based upon the microtask products received in 214 (step 216). In the embodiment depicted in FIG. 1, processing in 216 may be performed by TPMS 128. An action may then optionally be performed on the work product for the task constructed in 216 (step 218). For example, the final work product may be stored to memory, communicated to a task requester, etc.

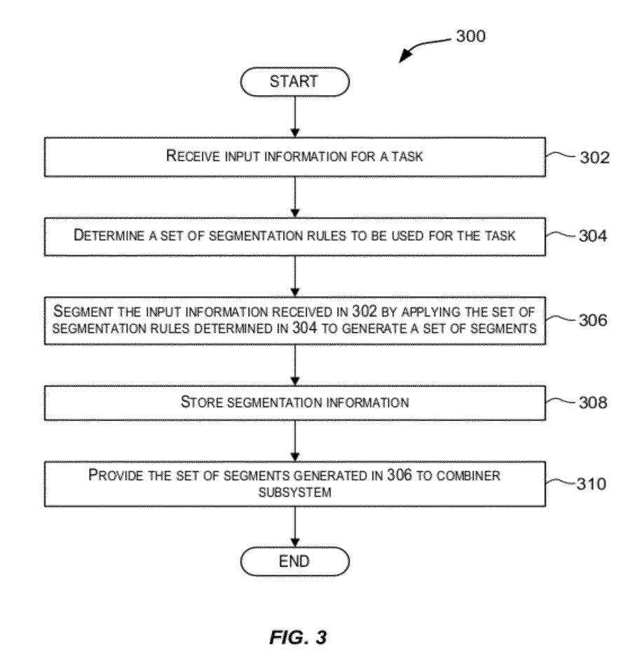

FIG. 3 depicts a simplified flowchart 300 describing processing performed for segmenting input information according to an embodiment of the present invention. The processing depicted in FIG. 3 may be performed by software (e.g., program, code, instructions) executed by a processor, by hardware, or combinations thereof. The software may be stored on a computer readable storage medium. The particular series of processing steps depicted in FIG. 3 is not intended to limit the scope of embodiments of the present invention as recited in the claims. In one embodiment, the processing depicted in FIG. 3 may be performed as part of step 204 of FIG. 2 and may be performed by segmenter subsystem 118 of FIG. 1.

As depicted in FIG. 3, processing may be initiated upon receiving input information for a task to be performed (step 302). A set of segmentation rules to be used for the task is determined (step 304). Various factors may be used to select the segmentation rules 304 such as the identity of the task requester, the source of the task request (e.g., IP address of a computer from which the task request is received, a geographical area from where the task request is received, etc.), the contents of the input information, and other factors. Constraints associated with the task to be performed such as an acceptable risk level, a desired quality level, a cost threshold, and the like may impact the selection of segmentation rules. The input information received in 302 is then segmented using the set of segmentation rules determined in 304 to create a set of one or more segments (step 306). Segmentation information is stored for the segmenting performed in 306 (step 308). The set of segments created in 306 is then provided to combiner subsystem 120 for further processing (step 310).

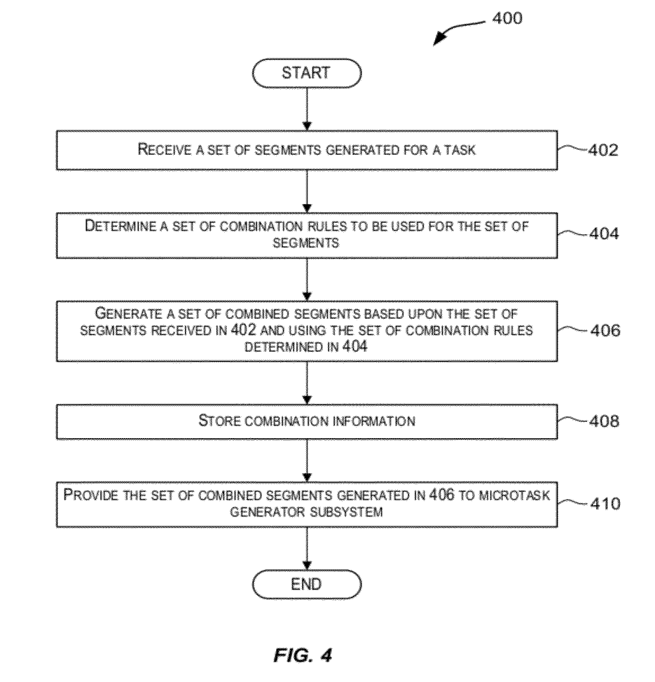

FIG. 4 depicts a simplified flowchart 400 describing processing performed for generating combined segments according to an embodiment of the present invention. The processing depicted in FIG. 4 may be performed by software (e.g., program, code, instructions) executed by a processor, by hardware, or combinations thereof. The software may be stored on a computer readable storage medium. The particular series of processing steps depicted in FIG. 4 is not intended to limit the scope of embodiments of the present invention as recited in the claims. In one embodiment, the processing depicted in FIG. 4 may be performed as part of step 206 of FIG. 2 and may be performed by combiner subsystem 120 of FIG. 1.

As depicted in FIG. 4, processing may be initiated upon receiving a set of segments generated from input information for a task to be performed (step 402). A set of combination rules to be used for generating combined segments is determined (step 404). Various factors may be used to select the combination rules in 404 such as the identity of the task requester, the source of the task request, the contents of the segments, and other factors. Constraints associated with the task to be performed such as an acceptable risk level, a desired quality level, a cost threshold, and the like may also impact the selection of combination rules in 404. A set of one or more combined segments are then created based upon the segments received in 402 and using the combination rules determined in 404 (step 406). Each combined segment may comprise one or more of the segments received in 402 or portions thereof. Combination information may be stored (step 408). In addition to other information, the combination information stored in 408 may include for each combined segment: information identifying the combined segment, information mapping a combined segment to its constituent one or more segments (i.e., information that the segments whose contents are included in the combined segment), location of segments within the combined segment, and other information. The set of combined segments created in 406 is then provided to a microtask generator subsystem 122 for further processing (step 410).

As previously described, whether or not combined segments are generated may depend upon the risk level associated with the task to be performed. Further, the combination techniques that are used to generate the combined segments may also differ for various different risk levels. Information related to a risk level threshold for generating combined segments and also the various combination techniques to be used corresponding to the various risk levels may be encoded in combination rules 138 that are used by combiner 120 for generating the combined segments.

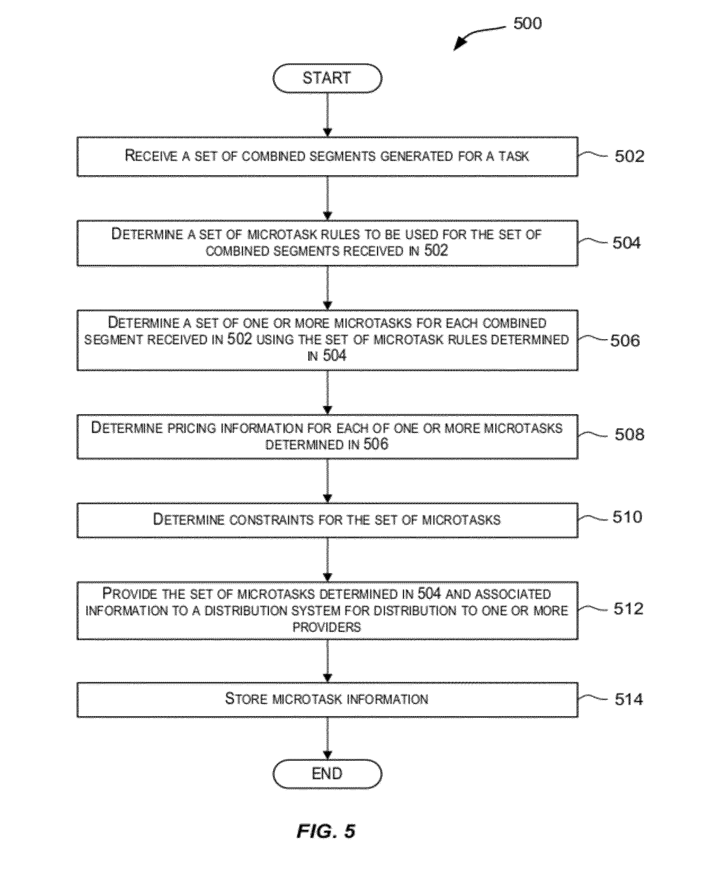

FIG. 5 depicts a simplified flowchart 500 showing processing performed by a microtask generator subsystem according to an embodiment of the present invention. The processing depicted in FIG. 5 may be performed by software (e.g., program, code, instructions) executed by a processor, by hardware, or combinations thereof. The software may be stored on a computer readable storage medium. The particular series of processing steps depicted in FIG. 5 is not intended to limit the scope of embodiments of the present invention as recited in the claims.

As depicted in FIG. 5, processing may be initiated upon receiving a set of combined segments for a task (step 502). A set of microtask rules may be determined for the set of combined segments received in 502 (step 504). Various factors may be used to select the microtask rules such as the identity of the task requester, the source of the task request, the contents of the combined segments, and other factors. Constraints associated with the task to be performed such as an acceptable risk level, a desired quality level, a cost threshold, and the like may impact the selection of microtask rules in 504. One or more microtasks are then determined for each combined segment received in 502 using one or more of the microtask rules determined in 504 (step 506). Pricing information may be determined for one or more of the microtasks determined in 506 (step 508). Processing for determining pricing information for the microtasks may use services provided by pricing subsystem 124. Constraints, if any, to be associated with the set of microtasks are determined (step 510). These constraints may include constraints related to individual microtasks in the set of microtasks and/or constraints related to the distribution of the microtasks to providers. Constraints associated with the task to be performed such as an acceptable risk level, a desired quality level, a cost threshold, and the like may impact the constraints determined for the set of microtasks in 510.

The set of microtasks along with their associated information is then forwarded to a distribution system for distribution to one or more providers (step 512). The information associated with the set of microtasks may include, for each microtask, a combined segment(s) that comprises content to be used as input for performing the microtask, pricing information determined for the microtask, constraints (if any) for the microtask, and distribution constraints associated with the set of microtasks. The microtask generator subsystem may also store microtask information for the set of microtasks (step 514). The microtask information may comprise information related to the microtasks including pricing information associated with each microtask, information mapping microtasks to their combined segments, the distribution system to which a microtask is forwarded (especially in embodiments where MMS 104 may use multiple distribution systems), and other information.

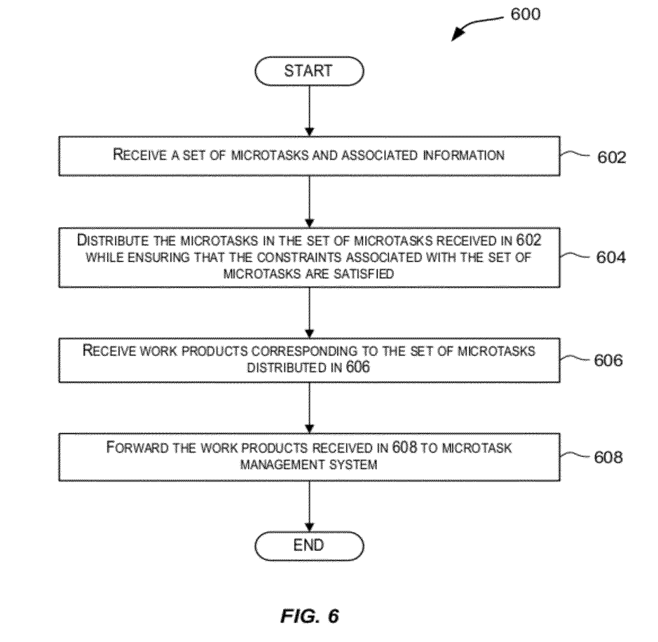

FIG. 6 depicts a simplified flowchart 600 showing processing performed by a distribution system according to an embodiment of the present invention. The processing depicted in FIG. 6 may be performed by software (e.g., program, code, instructions) executed by a processor, by hardware, or combinations thereof. The software may be stored on a computer readable storage medium. The particular series of processing steps depicted in FIG. 6 is not intended to limit the scope of embodiments of the present invention as recited in the claims.

As depicted in FIG. 6, processing may be initiated when the distribution system receives a set of microtasks and associated information (step 602). The associated information may comprise combined segments corresponding to the microtasks, and also potentially one or more constraints associated with the microtasks. The microtasks in the set of microtasks are then distributed by the distribution system (step 604). The distribution in 604 is performed such that any constraints associated with the microtasks are satisfied. The distribution system may also receive work products resulting from the performance of microtasks (referred to as microtask products) by the providers (step 606). The microtask products may then be forwarded to a microtask management system (such as MMS 104 depicted in FIG. 1) for further processing (step 608).

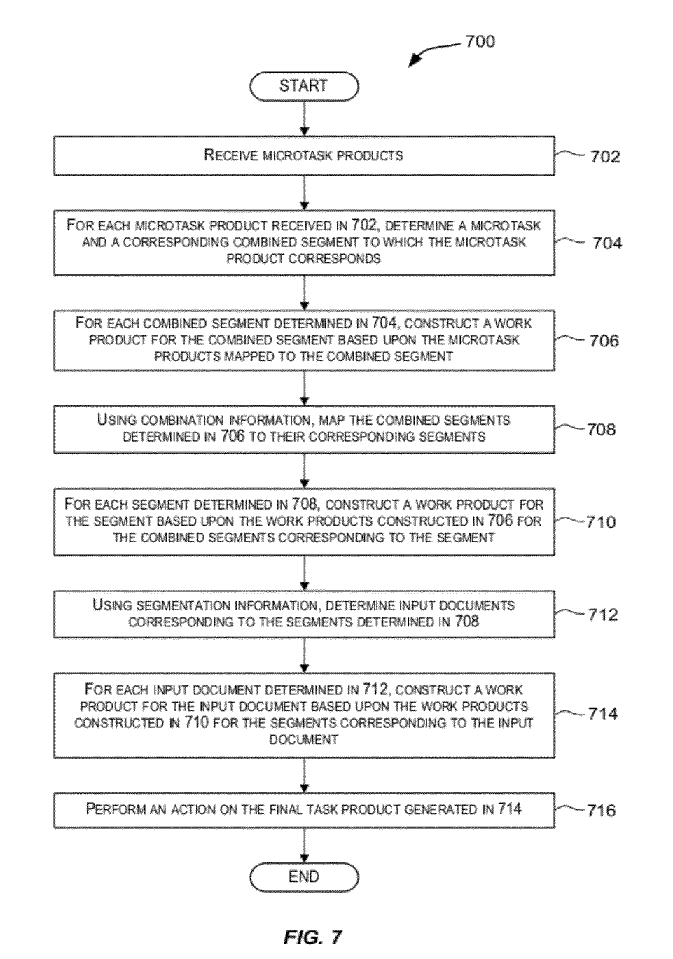

FIG. 7 depicts a simplified flowchart 700 describing processing performed for generating a final work product for a task based upon microtask products received for microtasks corresponding to the task according to an embodiment of the present invention. The processing depicted in FIG. 7 may be performed by software (e.g., program, code, instructions) executed by a processor, by hardware, or combinations thereof. The software may be stored on a computer readable storage medium. The particular series of processing steps depicted in FIG. 7 is not intended to limit the scope of embodiments of the present invention as recited in the claims. In one embodiment, the processing depicted in FIG. 7 may be performed as part of step 216 of FIG. 2 and may be performed by TPMS 128 of FIG. 1.

As depicted in FIG. 7, processing may be initiated upon receiving a set of microtask products (step 702). For example, MMS 104 depicted in FIG. 1 may receive a set of microtask products from distribution system 106 and the microtask products may be forwarded to TPMS 128 for processing. Each microtask product received in 702 is mapped to its corresponding microtask and associated combined segment determined (step 704). Since a microtask is associated with a combined segment, the processing in 704 essentially maps each microtask product received in 702 to a combined segment. In one embodiment, microtask information 146 may be used to map a microtask product to a microtask and its corresponding combined segment. A work product is then constructed for each combined segment determined in 704 based upon the microtask products that map to that combined segment (step 706). The combined segments determined in 704 are then mapped to their corresponding segments (step 708). In one embodiment, combination information 142, which stores information related to combined segments and their corresponding segments, is used to map combined segments to segments. A work product is then constructed for each segment determined in 708 based upon the work products constructed in 706 for the combined segments that map to the segment (step 710). The segments determined in 706 are then mapped to individual input documents (step 712). In one embodiment, this is performed using segmentation information 134. A work product is then constructed for each input document determined in 712 based upon the work products constructed in 710 for the one or more segments corresponding to the input document (step 714). The work products constructed in 714 represent the final work product for the task. One or more actions may optionally be performed on the final work product for the task constructed in 714 (step 716). The actions performed in 716 may include, for example, storing the final work product, communicating the final work product to a task requester, and the like.

Certain embodiments of the present invention provide techniques for pricing tasks. In an embodiment, the method includes receiving input information for a task to be performed and analyzing the input information to determine one or more attributes of the input information. In some embodiments the one or more attributes may include number of words in a text document, length of an audio/video content, complexity of the input information. The method further includes determining a set of one or more rules for determining pricing for the task and determining a price for the task based on the attributes of the input information and the set of rules.

Pricing of Tasks

Once a task and/or a microtask is defined e.g., by MMS 104, that task/microtask may be priced prior to the distribution subsystem providing the task to the worker system or the computer system. A task as used in the pricing context may be a task or a microtask as described in relation to MMS 104 or any other task that needs to be priced.

Embodiments of the present invention provides a method for determining a price for a task and/or a microtask. The method comprises receiving input information on/using which the task is to be performed and receiving task description associated with the input information. Thereafter using one or more rules related to the task and/or the input information, a price is determined for the task. In some embodiments, the same task may be priced differently based on the desired results, or type of input information.

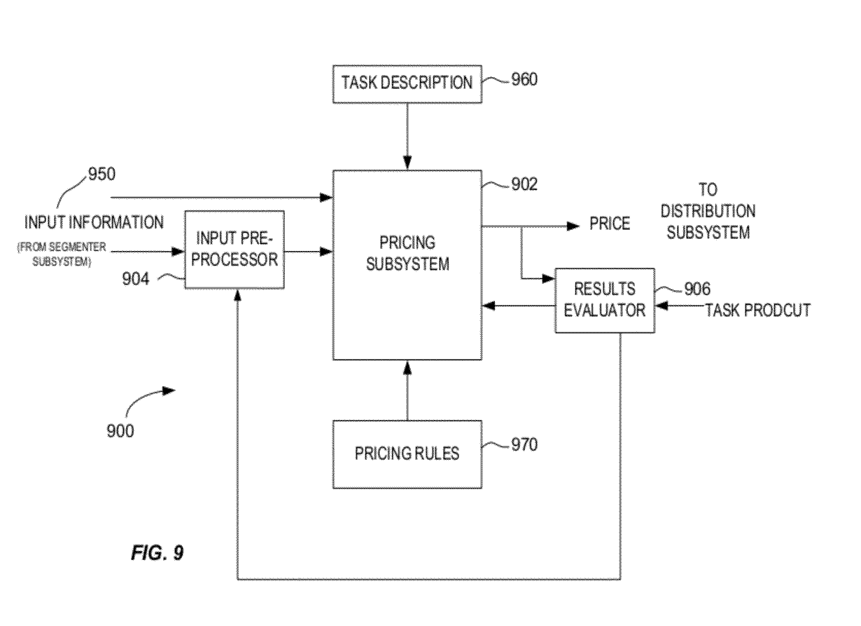

FIG. 9 depicts a simplified high-level block diagram of a system 900 for determining a price for a task according to an embodiment of the present invention. System 900 comprises a pricing subsystem 902, an input preprocessor 904, and a result evaluator 906. System 900 depicted in FIG. 9 is merely an example of an embodiment incorporating the teachings of the present invention and is not intended to limit the scope of the invention as recited in the claims.

Pricing subsystem 902 receives task description 960 related to a task, optionally receive input information 950 on/using which the task is to be performed, optionally receive any constraints associated with the task. Pricing subsystem 902 may then determine one or more pricing rules 970 to be applied for pricing the task based on task description 950 and optionally on input information 950. Pricing subsystem 902 then calculates a price for the task based on one or more applicable rules.

In some embodiments, pricing subsystem 902 may include a memory device. In some embodiments, the memory device may store programming instructions for determining price for a task. In some embodiments, memory 910 may also store the various pricing rules 970 to be used for determining a price for a given task. In some embodiments, memory 910 may comprise a database of statistical information related to task performance by each worker. This statistical information may be used to price and distribute tasks to workers to achieve an acceptable trade-off between price and quality.

In some instances, input preprocessor 904 may be used as part of the processing for determining a price for a task. In one embodiment, preprocessor 904 may be used to modify input information 950 received for a task in order to affect the pricing for the task. For example, in certain instances, preprocessor 904 may be configured to process the input information for a task prior to the task being priced and convert the input information to a form that may lower the price determined for the task. For example, if the input information is a rasterized image of a document that includes text, graphic, and image and the task is convert the document to a format for entry into a database, then the text, graphic, and image can be separated into individual segments and priced individually to lower the overall cost of the task.

Input preprocessor 904 may also receive input from result evaluator 906 and/or pricing subsystem 902 and use that information for modifying input information 950. In some embodiments, the results from completion of task are provided to results evaluator 960. Results evaluator 906 then checks the results for accuracy, time for completion, and other factors and provides that information to input preprocessor 904. Based on the results, input preprocessor 904 may modify the input information so that a balance between overall price and accuracy may be achieved. For example, consider a task where the contents of an input document are to be converted to digital entries of a database and the input document comprises both typed text and hand-drawn drawings. If maintaining a low price is the main criteria, the pricing subsystem may calculate the price based on the task being performed by a computer. However, after the computer performs the task and sends back the results, the results evaluator may verify the results for accuracy and find that while the text was properly translated, the drawing translation had very low accuracy. In this instance, the results evaluator may provide this information to the input preprocessor. In response to this information, the input preprocessor may modify the original document by separating the text and the drawings into two different segments. A first segment including the text is priced based on a computer performing the task of translation while a second segment including the drawings are priced based on a human performing the task of translation. In this manner the accuracy of the results may be improved while keeping the costs lower than what it would be if a human performed both the tasks. In some embodiments, input preprocessor 906 may be part of the microtask management system described above.

Results evaluator 906 may be configured to receive the results after completion of tasks and measure the results against one or more criteria. In some embodiments, results evaluator 906 may receive price information for a task from pricing subsystem 902 and provide feedback on whether the price matches a maximum price specified for that task. In some embodiments, the customer may specify one or more criteria to be used in evaluating the results received by results evaluator 906. In some embodiments, results evaluator 906 may be used for quality control of the workers performing the tasks. Based on the evaluations by results evaluator 906, a quality history for each worker may be stored in memory 910. In some embodiments, the quality information may be used by pricing subsystem 902 for determining price for a particular task.

Although pricing subsystem 902 and results evaluator 906 are illustrated as separate units in FIG. 9, in some embodiments, they both may be part of the same pricing subsystem 902. In other embodiments, pricing subsystem 902, results evaluator 906, and preprocessor 904 may be implemented as distinct components of a larger task generation and distribution system, e.g., the microtask management system 100 of FIG. 1.

As described above, pricing subsystem 902 receives other inputs in addition to the input information. One of the inputs to pricing subsystem 902 is pricing rules 970. Pricing rules 970 may be based on the attributes of the input information and/or one or more variables. For instance a rule might read, “if input information comprises audio and the task is to transcribe the audio to text, then the task shall be performed by a human worker.” Thus, when pricing subsystem determines the price for audio input information, it automatically knows to price the task based on a human worker performing the task. In some embodiments, pricing rules 970 may be hard-coded into pricing subsystem 902. In other embodiments, pricing rules 970 may be dynamic and customer configurable. In some embodiments, some pricing rules may be designated as default rules and may be associated with certain types of input information.

In some embodiments, the pricing rules may be based on attributes of the input information. Attributes of the input information may comprise type of input information, content of the input formation, complexity of the input information, or context of the input information. Of course, one skilled in the art will realize that this is not an exhaustive list and that many more attributes for the input information are possible. Each attribute may have one or more elements associated with it. For example, the attribute type of input information may comprise text, a rasterized image, a graphic, audio information, or video information. In some embodiments, the content of input information may be words, drawings, formulas, etc. It is to be understood that the list of variables described above is not exhaustive and is offered for illustrative purposes only.

Some examples of how price may be determined based on attributes of the input information will now be provided. It is to be understood that the examples provided below are not exhaustive but are merely descried to elucidate the concepts described above. Although the examples describe determination of price based on only one attribute, it is to be noted that in practice, price determination may involve interplay of a plurality of attributes in various permutations.

1. Type of input information—In some embodiments, the input information may be an audio stream and the task may be to transcribe the audio information to text. In such an instance, pricing subsystem may price the task based on a human performing it since traditionally computers have had poor voice recognition capability. In addition, human workers are better able to understand the context of a particular word than a computer.

2. Content of the input formation—In some embodiments, the input information may comprise only an image of text. In such an instance, the total number of words may be determined and pricing may be on a per word basis. In this situation, having a computer perform the task (e.g., OCR text recognition) may result in a lower price than using a human worker. In other embodiments, the customer may specify that only a human worker may be offered this task. In such an instance, price may be determined using the customer supplied constraint rather than some default.

3. Complexity of input information—In some embodiments, the input information may be in a form that is difficult to ascertain, e.g., prescription handwritten by a doctor. In such a scenario, the pricing subsystem may be directed to calculate a price based on a human performing the task since it is highly unlikely that a computer may provide meaningful results. In other embodiments, the input information may comprise a combination of audio information, text, and graphics. In such an instance, the input information may be segmented into three segments where a first segment comprises the audio information, a second segment comprises the text, and the third segment comprises the graphics. Each task for each of the segments may then be priced individually using default rules or customer specific rules.

In some embodiments, pricing of a task may depend on the total amount of content in the input information. In some embodiments, the input information may include multiple items of varying complexity such as words, graphics, image, etc. In this instance, multiple algorithms may be needed in order to properly analyze the input information and generate segments for purposes of creating microtasks. In some embodiments, where the input information is in the form of a rasterized image, an edge detection algorithm, e.g., Canny edge detection, may be used to detect a wide range of edges in the input image. Edge detection used in image processing and computer vision, for feature detection and feature extraction. An edge detection algorithm can identify points in a digital image at which the image brightness changes sharply or has discontinuities. In other embodiments, algorithms that can detect number of lines, number of characters, number of colors, etc. in the input information can also be used. In addition, normalized luminance histograms of an image, normalized edge histograms, color histograms can also be used for determining the complexity of the content in a rasterized image.

As described above, the price for a task may be based on input information and a set of one or more pricing rules 970. In some embodiments, pricing rules 970 may be based on one or more variables. For example, variables that may be used in determining which pricing rule to apply may comprise desired results of the task, geographical location of the worker who will perform the task, resources available to the worker who will perform the task, other tasks for the same input information, or any customer-specific rule, etc. Each variable may have several elements. For example, the variable desired results of a task may include desired accuracy, desired time of completion, etc.

The following paragraphs describe some examples of the variables that may be used to determine a pricing rule. It is to be noted that the listing of the variables is not meant to be exhaustive. The examples below are provided to explain how a pricing rule may be determined. One skilled in the art will realize that many more variables for determining a rule are possible.

1. Desired results of the task—In some embodiments, pricing may depend on the desired results of the task. Desired results of the task may include the desired accuracy of the results obtained after performing the task and desired completion time for the task. For example, pricing for a task that requires a high level of accuracy (90%+) may be more than price for a task that requires only average accuracy level (50%). Another element of the variable ‘desired results of a task’ may be desired completion time for the task. For example, rush jobs often cost more than standard lead-time jobs. In some embodiments, the same job may be sent to multiple workers and the results compared until a statistically significant agreement in the results is reached. In another embodiment consider that some English language text is to be converted to Chinese. If the customer wants the task completed within few hours when it is daytime in the US, the resulting pricing rule would indicate that the job is to be performed in the United States due to the completion time constraint. In this instance the price will be calculated based on the task being performed in the United States. However, if the customer is willing to wait until the next day, the same task may be priced using a different rule, e.g., based on the task being performed in China, which may result in a lower cost for the task.

In some embodiments, a task may be divided into smaller microtasks by taking into account the price charged by a worker and the quality history of the workers in order to get the highest quality within given financial constraints, e.g., target price. For example consider that the task is to convert an English language document into Chinese. Consider that a worker A charges 3 cents/per word for translation and has an accuracy of 95%, while a worker B charges 1 cent/word and has an accuracy of 70%. If both workers bid on the job for the translation and a high level of accuracy is needed, the customer may accept the bid from worker A since his accuracy is much higher than worker B. In other embodiment, if the amount of money that the customer is willing to spend is fixed, the document may be divided into two segments, segment 1 including difficult to translate information and the segment 2 including easy to translate information. A microtask may be assigned to each of segments 1 and 2. Segment 1 may be sent to worker A and segment 2 may be sent to worker B for translation. This may help to achieve high overall accuracy for the translation while keeping the total cost within the target price by having both workers only translate part of the document each. In yet another embodiment, the translation task may be given to worker B. The results of the translation may then be provided to worker A for verification and correction as needed. In this embodiment, worker A will likely spend less time for the task since he is merely verifying the translation performed by worker B rather than doing the translation from scratch. This may help to reduce the overcall cost of the translation task and still maintain a fairly high level of accuracy in the results.

In some embodiments, selection of workers can be based on the target price for a task. In one instance, if the task requester provides a target price for a task, the MMS system can determine a subset of workers, from the total amount of workers, who are eligible to perform that task based on the target price. The task can then be offered only to that sub-set of workers. For example, consider that the target price for the task is $5. Based on that price, the MMS can determine that the task cannot be completed in the United States as the target price of $5 is lower than what it would cost to perform the task in the United States. In this instance, the MMS would only choose workers in geographical locations who could perform the task at the target price thereby automatically eliminating workers in United States from consideration.

2. Geographical Location of the Worker who will perform the task—In some embodiments, the geographical location of the worker may be used in price calculations. Workers in countries with lower wages are likely to perform a given task for a lower price than a worker in a country with higher wages. In some embodiments, the nature of the task may be such that the task has to be performed within the country of origin, e.g., regulatory restrictions. In such an instance, the resulting rule may restrict calculation of the price for the task to be based on the task being performed within a certain geographical region.

3. Skills required by the worker—In some embodiments, the price may depend on specific skills needed by a worker for performing the task. For example, a task of converting a hand-drawn drawing to an AutoCAD™ drawing may need a worker with good drafting skills. In this situation, the price for the task will depend on the special skills of the worker needed to perform the task and will likely be high.

4. Resources available to the worker—In some embodiments, the price determined for a task may depend on the resources available to the worker who performs the task. For example, if a task requires the worker to use specialized hardware or software, the price of that task may be higher. In such an instance, the price for the task may be reduced by making the task simpler (i.e. eliminating the need for specialized hardware and/or software or providing the specialized resources to the worker).

As discussed above, pricing for a task may depend on the various pricing rules. In some embodiments, the customer may specify the rules to be used for a pricing a task. For example, the customer may only want human workers to perform his tasks. The customer may provide this information to the pricing subsystem and the pricing subsystem will use this rule whenever it calculates price for a task specified by that customer. In some embodiments, default rules maybe used for price determination. For example, if the input information content is text only and the task is to convert the text to an electronic format, the pricing subsystem may be preprogrammed to choose a computer worker and price the task accordingly. Of course, the customer or the pricing subsystem operator may override any default settings based on the specific requirements of the task.

In some embodiments, pricing for a task may depend on the number of tasks associated with the given input information. For example, consider that the input information comprises text and images. There may be two tasks defined for the input information such as, convert the text into a MS Excel file format and convert the image into a MS Visio format. In such a situation, the pricing for each of the tasks may depend on the other task associated with the input information. In some embodiments, pricing for a task may depend on other tasks for other input information being priced by the pricing subsystem, which may or may not be related to the task.

In some embodiments, the customer may specify a target price for a task. In such an instance, the pricing subsystem may calculate a price for a task based one or more of the factors described above. The result of the price calculation may then be compared against the target price. If the calculated price is lower than the target price, the calculated price is provided to the distribution subsystem for distribution to an appropriate worker. In some embodiments, the customer may provide a tolerance limit for the target price. For example, the customer may specify a target price of $100 with a ±5% price tolerance. In this instance, as long as the calculated price is between $95 and $105, it is approved. However, if the calculated price is higher than the target price, that information may be communicated to the input preprocessor. The input preprocessor may then modify the input information and/or the task properties in conjunction with the segmenter subsystem. The modified input information is then provided to the pricing subsystem for calculating a second price in order to match the target price or get a lower price than the target price. For example, consider that the input information comprises a rasterized image and the rasterized image comprises a drawing and name of the person who created the drawing. Consider that the task is to recreate this drawing in MS VISIO along with the name of the person. The customer has set a target price of $50 for this task. In the first pass, the entire image is presented as a single unit for pricing of the task. Since the input information predominantly includes a drawing, the pricing subsystem may determine, based on one or more rules described above, that a human worker is needed to recreate this drawing in VISIO and accordingly price the task at $75. This calculated price is compared to the target price. Since the calculated price is higher in this instance, this information may be communicated to the input preprocessor. The input preprocessor, in conjunction with the segmenter subsystem, analyzes the input information and determines that there is a textual component in the image (i.e. name of the person). The input information is then split into two segments, one segment comprising the textual information and other segment comprising the drawing. The task for the textual information segment is priced based on a computer performing the transcription and the task for the drawing segment is priced based on a human performing the transcription. The total price for the two segments in this situation may be $50, since part of the transcription is being done by a computer, which may be cheaper than a human worker. Thus, it may be possible to obtain a lower price for a task by modifying the input information and/or the task properties.

In some embodiments, where high accuracy is needed, the same task may be sent to multiple workers. However, this may significantly increase the price of the task. In some embodiments, instead of multiple people performing the same task, the task itself may be modified each time in order to reduce the price. For example, during the first pass a first worker may be asked to transcribe a very complex document. The results obtained from the first pass may be sent to a second worker with the task being to verify the work of the first worker. Since the second worker in merely verifying the results from a previous task, the price for the second pass will be cheaper. Similarly, results from each pass may be resubmitted for verification. Each subsequent task for verifying the results of a previous task will be cheaper as less work is needed each time. This may result in lower overall price for the task while achieving high accuracy level.

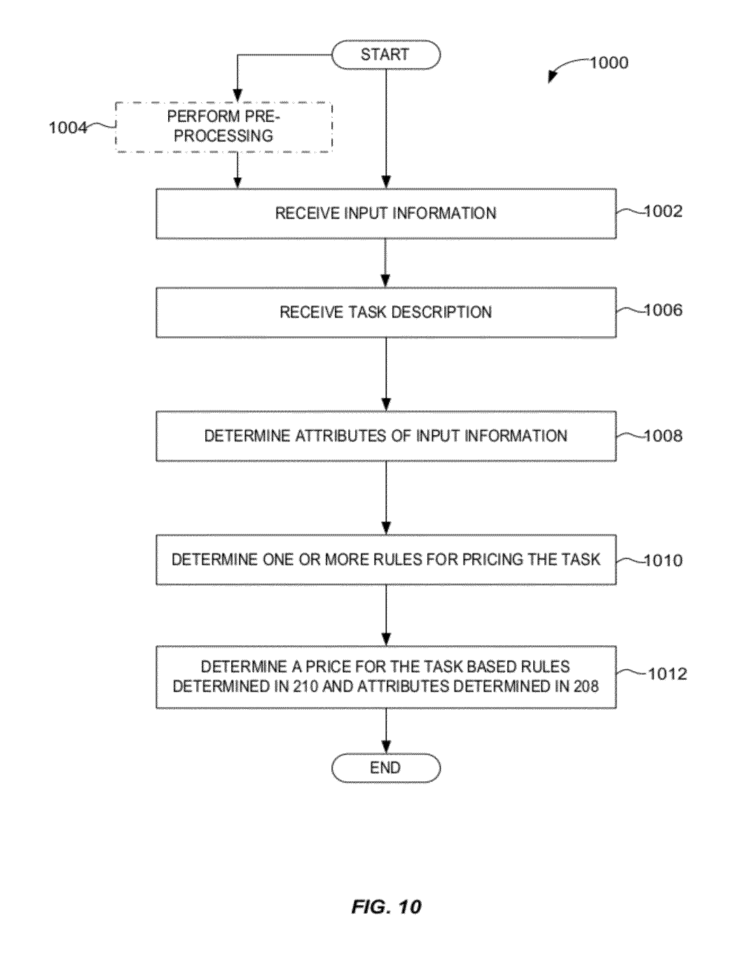

As described above, system 900 may be used to determine a price for a task. FIG. 10 is a flow diagram of a process 1000 for determining price for a task according to an embodiment of the present invention. Process 1000 may be performed e.g., by pricing subsystem 902 of FIG. 9. At step 1002, the pricing subsystem receives input information. In some embodiments, the input information may need to be modified as described above. In such situations, the input information is preprocessed at step 1004 before being communicated to the pricing subsystem at step 1002. In addition to the input information, the pricing subsystem also receives the task description at step 1006. The task description provides details on the operation to be performed on or using the input information. For example, the task description may specify that the drawing in the input information is to be converted to a MS Visio drawing. Once the pricing subsystem receives the input information and task description, the pricing subsystem determines the attributes of the input information at step 1008. Attributes of the input information may comprise the contents of the input information, the type of content of the input information, the complexity of the input information, etc. As described above, these attributes of the input information may be used for calculating a price for the task.

At step 1010, the pricing subsystem determines the rules to be applied for pricing the task. In some embodiments, there are certain default rules that apply to particular type of input information. In addition, the customer may provide certain restrictions to be used as part of the price determination, as described above. In some embodiments, one or more rules may be applicable for the input information. At step 1012, the pricing subsystem applies the determined rules and uses the attributes of the input information to determine a price for the requested task. In some embodiments, once the price is determined, it may be communicated to a distribution subsystem for distribution of the task to a worker. In some embodiments, the pricing information may be communicated to a results evaluator, as described above, for comparison with a target price.

It should be appreciated that the specific steps illustrated in FIG. 10 provide a particular method of determining price for a task according to an embodiment of the present invention. Other sequences of steps may also be performed according to alternative embodiments. For example, alternative embodiments of the present invention may perform the steps outlined above in a different order. Moreover, the individual steps illustrated in FIG. 10 may comprise multiple sub-steps that may be performed in various sequences as appropriate to the individual step. Furthermore, additional steps may be added or removed depending on the particular applications. One of ordinary skill in the art would recognize many variations, modifications, and alternatives.

Embodiments of the present invention may be used in a variety of applications. The following sections disclose some of the application that may use the task generation and pricing techniques described above. However, it is to be understood that the list of applications described herein is not exhaustive and many more applications may use the embodiments described above.

### Handwriting Recognition

Although computer algorithms for the recognition of printed and handwritten text have continued to improve, human recognition is still the standard by which such algorithms are judged. Humans may be better at using context and may recognize and adjust to multiple different types of distortion in the text. In such an instance, the techniques for creation and pricing of microtasks, described above, may provide an advantage over traditional method of recognizing handwritten text.

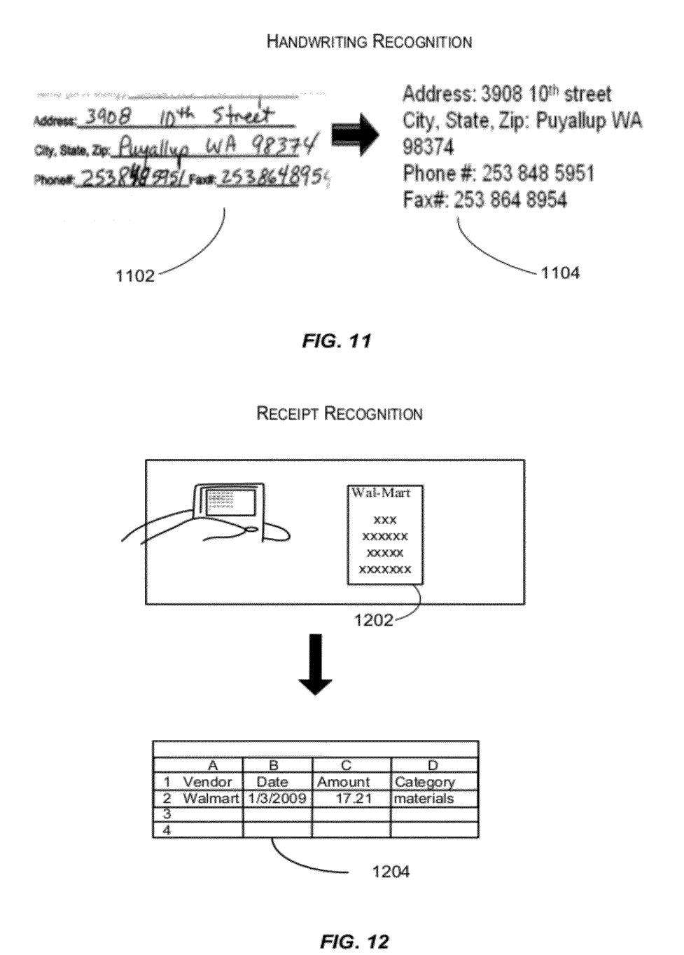

FIG. 11 illustrates transforming handwritten text into typed text. FIG. 11 shows a handwritten address book entry 1102 that need to be converted to a typed text 1104. In some embodiments, resulting typed text 1104 may be populated in a database. A service to convert handwritten text into typed text may be offered to customers on a per task basis. In some embodiments, the service may be implemented via a portal that the customers may access to submit the tasks. In some embodiments, the portal may be accessed over the World Wide Web. In one embodiment, several microtasks may be created for the transformation of the handwritten text. In an embodiment, the customer may capture an image of the handwritten text using e.g., a camera. The customer may then access a website using a web browser on a customer device, e.g., the task requester system 102 illustrated in FIG. 1, to provide the captured rasterized image along with a task description detailing the desired operation to be performed on the captured image and a task disposition to, e.g., a microtask management system 100 of FIG. 1. For example, the task disposition might be to communicate the results of the job to a server accessible by the customer. Alternatively, the disposition may comprise emailing the results to a specified email address.

In an embodiment, the microtask management system receives the rasterized image and task description from the task requester system. The microtask management system may check to see if the customer has enough credits or has a billable account or sufficient permission to use the service. The microtask management system may then format the rasterized image for distribution by, e.g., the distribution system 106 of FIG. 1. In some embodiments, the rasterized image may be divided into several segments and a microtask may be assigned to each segment based on various rules and input information attributes described above. The microtask management system transmits the task description and some account information to the worker system. In some embodiments, the account information transmitted to the worker system may be different from the account information provided by the customer. In some embodiments, the customer is not required to have an account with the worker system.

The microtask management system continues to monitor task progress as provided by the worker system. The microtask management system may cancel and reissue a task, change the amount offered to workers for a task, or even change the task and resubmit. The microtask management system might combine input information from multiple task requester devices and assign a single task for the combined input information. In some embodiments, the microtask management system may split one task into multiple tasks and then distribute to the worker system.

Once the microtask management system has received sufficient task results back from the worker system, the microtask management system via the task product management subsystem, may provide the results to the task requester system of the customer e.g., by emailing the results or storing the results in a location accessible by the customer.

In some embodiments, the task requester system may be a mobile communication device that comprises a camera and has the capability to access the Internet. In other embodiments, the task requester system may be a scanner or a multifunction device that may capture the image, and provide the information to the microtask management system. In some embodiments, the task requester system may be shared by multiple customers who may use the same credentials to gain access to the service. Other types of devices that may be used to provide the input information and the task description comprise tablets, slates, music players, cars, etc. In some embodiments, the task requester system may provide an interface to the customer where the customer may provide the input information by handwriting the input information directly onto the task requester system. Examples of such devices comprise a device with a touch input, e.g. a region sensitive to a finger or any contact, or a device with a region sensitive to a stylus. In this instance, the input received by the task requester system may be combined with an image already available to the task requester system and then provided to the microtask management system. In another embodiment, the task requester may provide ‘stroke’ information rather than an image. Stroke information comprises information about the points of contact on a touch input, and may be saved as a list of points rather than as an image. For example, InkML (http://www.w3.org/TR/InkML/) specifies a way to use XML to record strokes. Thus, in an embodiment, the task requester might provide InkML rather than a rasterized image to the microtask management system. The microtask management system may convert the stroke information to an image format for submission to the worker system and/or automated system for recognition by the worker.

### Receipt Recognition

For every item that is purchased or returned, a receipt, in some form, is issued to the buyer. Each merchant may have a proprietary format for receipts. However, certain information is common to all receipts, e.g., the total amount and item information. A person may accumulate a large number of such receipts over a very short period of time. For example, a person on a three week business trip may end up with over 100 receipts from various merchants. Keeping track of such receipts may get very cumbersome and time consuming, especially if the receipts are needed for expense reimbursement later. It would be helpful if the relevant information in the receipts can be converted to an electronic format at very low cost to the person.

FIG. 12 illustrates an application where the contents of a receipt 1202 may be recognized and converted to electronic format 1204, e.g., a excel worksheet expense report. A customer may have one or more receipts that need to be recognized in order to create an expense report. The task requester system may be used to obtain rasterized image of each receipt. In some embodiments, each receipt may comprise different information and/or different formatting. A large portion of the information in each receipt may not be needed to create expense report. For example, the customer may indicate a task description to comprise recognition of the date, the store name, and total amount information only. The microtask management system receives the image of each receipt and the task description for a creating a list of date, store name, and total amount. The microtask management system may then create several microtasks and submit them to the worker subsystem. In this instance, the worker may be asked to identify regions of each receipt image that contain the date, the store name, and the total amount. The worker may do this by visiting a website that presents the image of each of the receipts and dragging across a portion of the image for each desired piece of information (e.g., date, store name, and total amount). In this instance, each receipt image may be split into multiple sub-images where each sub-image comprises at least one of the requested information (i.e. date, the store name, or the total amount). Each sub-image may be characterized by co-ordinates in the plane occupied by the receipt image. Each sub-image may be identified using its location within the receipt image.

Human input is particularly valuable for this operation because each receipt may comprise multiple numbers formatted as an amount. Therefore a computer may not be able to discern the relevant number, e.g., the total amount. In addition, the date may be formatted in different ways on the receipts, which may make it difficult for a computer to determine the date accurately. When the human worker indicates the coordinates of the requested information on the receipt image, the indicated sub-images may be sent to an automated character recognition system for further processing. In this case, the results from multiple sub-images may be combined into one result for the customer by the task product management subsystem. The result may be in the form of a spreadsheet, or table, or even a direct entry into some accounting system. Alternatively the worker system may submit the images of the receipts initially to an automated character recognition system and then provide the symbolic text generated by the character recognition system to a human worker. The human worker may select the symbolic text corresponding to the date, time, and total amount. In yet another embodiment, the human worker may be asked to directly type the date, store name, and amount from the image without any automatic recognition processing.

### Business Card Recognition

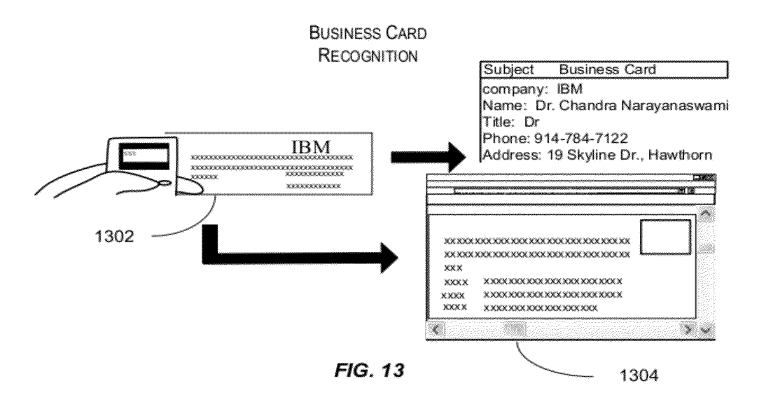

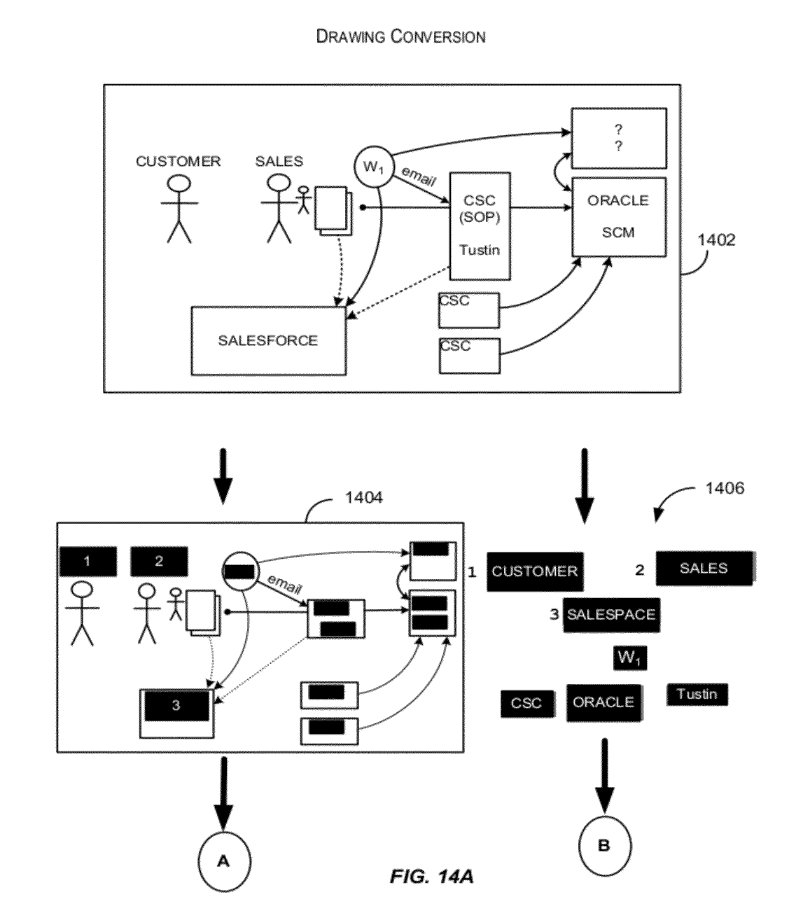

A business card is the most commonly used tool for exchanging professional information among business persons. A person may accumulate a significant quantity of business cards even over a short period of time, e.g., a trade show. Since most business cards are in a paper format, they are prone to damage or being lost. It would be helpful to convert the information in these business cards into an electronic format for easy storage and retrieval. FIG. 13 illustrates a method for converting information in a business card into an electronic format according to an embodiment of the present invention.

FIG. 13 illustrates contents of a business card 1302 that may be converted to an electronic format 1304 according to an embodiment of the present invention. Business cards come in a variety of formats but comprise common types of information. Business cards typically comprise a person's name, a company name, a phone number, and an email address. In some instances, business cards they may also comprise additional information like websites, titles, a physical address, a fax number, a twitter account, and graphics, e.g., company logo. Business cards may be often collected in groups, e.g. at a business meeting, or after making several sales calls.

In an embodiment, rasterized images of one or more business cards may be acquired by the task requester system. The images are provided to the microtask management system. Based on the images, the microtask management system creates one or more task descriptions that ask a worker to identify and possibly recreate the information in the images. In some embodiments, the image of the business card may be segmented into words and the words may then be sent to workers in different geographic locations. In some embodiments, words from different business cards can be mixed with each other prior to generating a microtask for their translation. The segmented words can be grouped together in a logical manner but such that it preserves the privacy of the person to whom the business card belongs. For example, the email address and name of the person may not be grouped together. In another example, phone/fax numbers from different business cards can be grouped into the same sub segment to provide a context to the worker performing the microtask associated with that sub-segment. Examples of segmentation techniques are described in Berna Erol at al., “HOTPAPER: Multimedia Interaction with Paper using Mobile Phones”, ACM Multimedia Conference, 2008, Vancouver, British Columbia, Canada, pp. 399-408, the contents of which are incorporated by reference herein in its entirety for all purposes.

The logo on a business card may be extracted using a logo detection algorithm. In some embodiments, the microtasks generated for a particular business card or a set of business cards may be performed using a combination of human and automated processing. The work product management subsystem may receive the results of the microtasks in the form of vCards (a standard for maintaining contact information), a table, a spreadsheet, or contact storing format. The microtask management system may enter the information directly into a backend system, e.g., a corporate CRM system, personal contact storage, or a social networking website. In the instance that the results are directly populated in a social networking system, e.g. LinkedIn, if the microtask management system is provided with the customer credentials for the social networking system, the microtask management system may use the email address from a card to request connections in the social networking system. FIGS. 8A and 8B and the associated description describe the details of a business card recognition process implemented using an embodiment of the present invention.

FIGS. 8A and 8B and the associated description also describe how microtasks may be generated for recognizing info from one or more business cards. In one embodiment, the words extracted from a business card can be sent to workers that have different ids and/or in different geographic locations. The words from one business card may also be mixed with words from different business cards. A company logo a business card may be extracted and sent to an automatic logo detection algorithm. The segmented words can be classified into logical segments where an email address and name of a person are identified from the business card and grouped into different combined segments (i.e., not grouped into the same segment) in order to preserve privacy. In one embodiment, phone/fax numbers extracted from different business cards may be grouped into the same combined segment to maximize the likelihood of high quality output by giving a worker the context (of numbers) in the task.

### Drawing Recognition

Often during meetings, people use a white board to present their ideas in a visual format, e.g., a hand-drawn sketch. One way to capture such information is for someone in the meeting to copy the sketch and recreate it in an electronic format, e.g., PowerPoint slide, for distribution to relevant personnel. However, such a task often takes up valuable time of the concerned person. It may be helpful to outsource such a task using the embodiments of the invention discussed above.

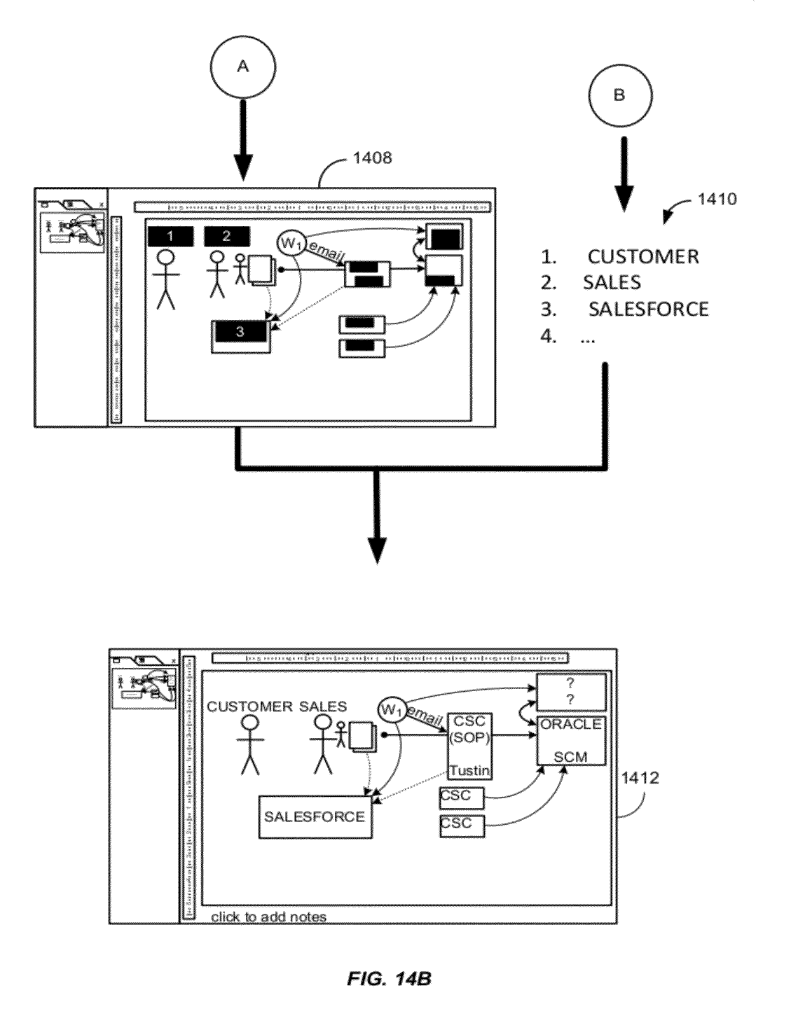

In an embodiment, the rasterized image provided by the task requester system may comprise diagrams or simple graphics. The location of the various graphics elements (such as lines, boxes) in the rasterized image may be different compared to the input rasterized image. This may make it difficult to register the input image and the output result and preserve the initial layout of the graphics. In this case, a microtask or several microtasks may instruct the worker to convert the diagram or the graphic into an electronic form using particular software, e.g. Power Point or Visio. FIGS. 14A and 14B illustrate an embodiment where a hand-drawn sketch 1402 that includes drawing components, e.g., lines, rectangles, etc. and text is converted into a sketch 1412 in a desired electronic format using the microtasks generation and pricing system described above. In one embodiment, sketch 1402 may be drawn on dry erase board commonly used during meetings.

After sketch 1402 is completed, an image of the sketch can be captured using any of the conventional image capturing equipments such as a camera. Once the image is captured, it may be presented as an input to the microtask generation system describe above. Once the image of sketch 1402 is received by the microtask generator system, the image is analyzed to determine the text and graphical/drawing portions of the sketch. In one embodiment, the system recognizes the word boundaries and marks them, e.g., blacks them out from the image, leaving only the graphical/drawing portion 1404. Each of the blacked out section is numbered for tracking purposes. The numbering may be later used when reconstructing the original sketch. The system then analyzes the word or words 1406 present in the sketch 1402 and separates them from the image. The system then generated correlation information between the blacked out sections and the words and stores the correlation information in a database.

The microtask management system then creates two microtasks, a first microtask for converting the first portion 1404 of the sketch into an electronic format and second microtask for converting one or more words 1406 into a desired format. Thereafter the first and the second microtask can be priced based on the desired results and rules described above. Upon completion, the first microtask may yield a drawing 1408 that includes numbered segments that correspond to the words in the original sketch 1402. The second microtask may yield a list of words 1410, each corresponding to the respective numbered segment on drawing 1408. In some embodiments, the second microtask may be sent to a computer or may be performed by a human depending on the desired results. Once the microtask management system receives the results of the microtasks, it can combine the two results, e.g., using task product management subsystem 128 of FIG. 1, to generate a final drawing 1412 by replacing the numbers segments in drawing 1408 with the corresponding words from the list of words 1412.

In some embodiments, instead of creating a microtask for converting the words in the sketch, the words 1406 may be sent to an automated character recognition engine, e.g., www.abbyy.com, for analysis and conversion.

It is to be noted that the example provided in FIGS. 14A and 14B is for illustration purposes only and should not be construed to limit the embodiment to hand-drawn sketches/graphics.

### Checkbox Recognition

The method of generating and pricing microtasks may be effectively used for converting form data into data that may be analyzed for data mining. There are various types of forms that users are asked to fill. Forms may comprise registration forms, survey forms, feedback forms, etc. Many of these forms comprise some form of check boxes that the user is expected to fill in. Often there is no set rule on how to fill-in the check boxes. Users often provide a wide range of indicators to fill-in a check box. In some embodiments, the indicators may comprise an ‘x’ mark, a check mark, completely filled-in checkbox, etc. Many automated processes for identifying checkbox status may easily detect clear ‘x’ marks or completely filled in boxes. However, most of the automated systems are unable to properly determine the status of a checkbox if the checkbox is partially filled or a casual mark is placed in the check box. Further, if a user crosses-out a checkbox and selects another one or annotates a check box, the automated system may not properly detect the user's intention and may invalidate the checkbox. In these instances, a human worker may be able to provide a more accurate result.

In an embodiment, an image of the checkboxes is provided to the worker and the worker may indicate whether or not a box is checked. The results are then provided to the task product management subsystem for delivery to the customer. In some embodiments, a worker is presented with multiple check boxes from the same user since it is likely that the user will have filled in the check boxes in a consistent manner. This may increase the accuracy and speed of the worker performing the checkbox status determination. In some embodiments, the microtask management system may automatically group checkboxes that are thought to be marked and those that are considered empty. In this instance, the worker may be asked to identify any check boxes which have been misclassified. This may be done more quickly than indicating the status of all boxes.

Some of the other applications that may benefit from microtask generation and pricing techniques described above comprise a) finding particular information from a huge amount of data, b) fixing errors in documents, c) comparing various data sets to find a match, d) determining directions for someone, e) grouping data using customer provided criteria, f) Extracting proper names from given data, g) Translating words into a specified language and format, h) speech recognition and transcription, and i) detecting logos from the given data. One skilled in the art will realize that many more applications not specifically enumerated herein may be implemented using the techniques described above.

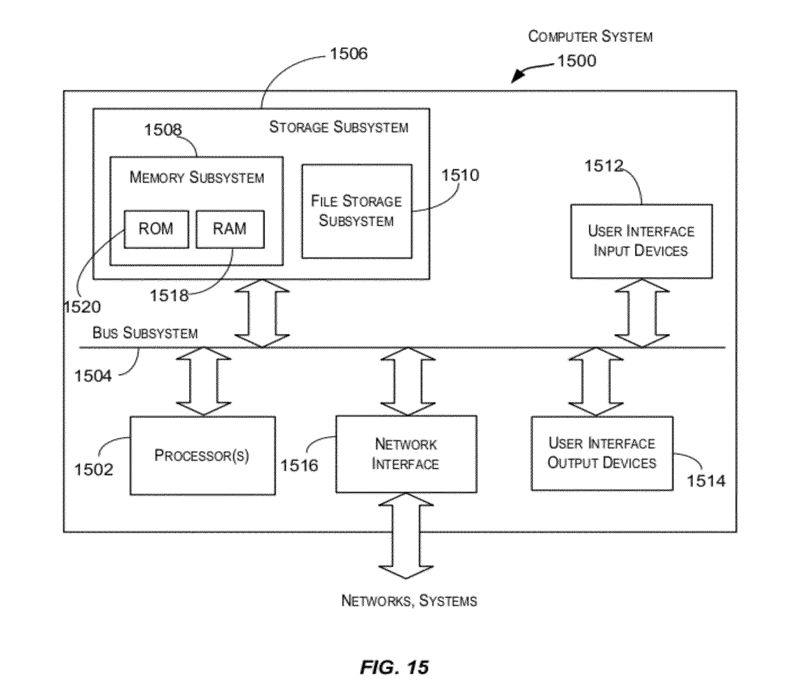

FIG. 15 is a simplified block diagram of a computer system 1500 that may be used to practice an embodiment of the present invention. In various embodiments, computer system 1500 may be used to implement any of the systems illustrated in FIG. 1 and described above. For example, computer system 1500 may be used to implement task requester system 102, MMS 104, distribution system 106, or a provider system. As shown in FIG. 15, computer system 1500 includes a processor 1502 that communicates with a number of peripheral subsystems via a bus subsystem 1504. These peripheral subsystems may include a storage subsystem 1506, comprising a memory subsystem 1508 and a file storage subsystem 1510, user interface input devices 1512, user interface output devices 1514, and a network interface subsystem 1516.

Bus subsystem 1504 provides a mechanism for enabling the various components and subsystems of computer system 1500 to communicate with each other as intended. Although bus subsystem 1504 is shown schematically as a single bus, alternative embodiments of the bus subsystem may utilize multiple busses.

Network interface subsystem 1516 provides an interface to other computer systems and networks. Network interface subsystem 1516 serves as an interface for receiving data from and transmitting data to other systems from computer system 1500. For example, network interface subsystem 1516 may enable a user computer to connect to the Internet and facilitate communications using the Internet.

User interface input devices 1512 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, use of the term “input device” is intended to include all possible types of devices and mechanisms for inputting information to computer system 1500.

User interface output devices 1514 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 1500.

Storage subsystem 1506 provides a computer-readable storage medium for storing the basic programming and data constructs that provide the functionality of the present invention. Software (programs, code modules, instructions) that when executed by a processor provide the functionality of the present invention may be stored in storage subsystem 1506. These software modules or instructions may be executed by processor(s) 1502. Storage subsystem 1506 may also provide a repository for storing data used in accordance with the present invention. Storage subsystem 1506 may comprise memory subsystem 1508 and file/disk storage subsystem 1510.

Memory subsystem 1508 may include a number of memories including a main random access memory (RAM) 1518 for storage of instructions and data during program execution and a read only memory (ROM) 1520 in which fixed instructions are stored. File/disk storage subsystem 1510 provides a persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media. File/disk storage subsystem 1510 may store information such as the input information for a task, work products received from performing microtasks, rules that are used by MMS 104, the final work product generated for the task, information related to factors and constraints associated with a task to be performed (e.g., information related to risk, quality, etc.), and the like.

Computer system 1500 can be of various types including a personal computer, a phone, a portable computer, a workstation, a network computer, a mainframe, a kiosk, a server or any other data processing system. Due to the ever-changing nature of computers and networks, the description of computer system 1500 depicted in FIG. 15 is intended only as a specific example for purposes of illustrating the preferred embodiment of the computer system. Many other configurations having more or fewer components than the system depicted in FIG. 15 are possible.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, this is not intended to limit the scope of inventive embodiments.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention.

What is claimed is:

1. A computer-readable storage medium storing a plurality of instructions for controlling a computer system, the plurality of instructions comprising:
instructions that cause the computer system to receive information identifying a task and input information for the task;
instructions that cause the computer system to determine a risk threshold for the task;
instructions that cause the computer system to determine, based upon the risk threshold, a plurality of microtasks for performing the task, each microtask associated with a portion of the input information;
instructions that cause the computer system to distribute the plurality of microtasks to a plurality of workers;
instructions that cause the computer system to receive a plurality of work products resulting from performance of the plurality of microtasks by the plurality of workers; and
instructions that cause the computer system to generate a final work product for the task based upon the plurality of work products resulting from performance of the plurality of microtasks.

2. The computer-readable storage medium of claim 1 wherein the instructions that cause the system to determine the plurality of microtasks comprise instructions that cause the computer system to segment the input information into a set of segments based upon the risk threshold, each segment comprising a portion of the input information.

3. The computer-readable storage medium of claim 2 wherein the instructions that cause the system to determine the plurality of microtasks further comprise instructions that cause the computer system to generate a combined segment based upon the set of segments and the risk threshold, the combined segment comprising information from at least one segment from the set of segments and additional data not included in the input information.

4. The computer-readable storage medium of claim 2 wherein the instructions that cause the system to determine the plurality of microtasks further comprise:
instructions that cause the computer system to generate a set of combined segments based upon the set of segments, the set of combined segments comprising at least one combined segment comprising information from at least two different segments from the set of segments; and
instructions that cause the computer system to determine the plurality of microtasks based upon the set of combined segments.

5. The computer-readable storage medium of claim 4 wherein:
the input information comprises a first document and a second document;
the set of segments comprises a first segment comprising a portion of the first document and a second segment comprising a portion of the second document;
the set of combined segments comprises a first combined segment comprising contents of the first segment and the second segment;
the plurality of microtasks comprises a first microtask to be performed using the first combined segment as input.

6. The computer-readable storage medium of claim 1 wherein the plurality of instructions further comprises:
instructions that cause the computer system to output a quality estimate for the final work product, wherein the quality estimate is based upon quality estimates associated with the plurality of work products resulting from performance of the plurality of microtasks.

7. The computer-readable storage medium of claim 6 wherein the plurality of instructions further comprises:
instructions that cause the computer system to determine, based upon the quality estimate, if a second set of microtasks is to be determined for the task.

8. The computer-readable storage medium of claim 1 wherein the plurality workers comprises at least one human worker.

9. The computer-readable storage medium of claim 1 wherein:
the plurality of instructions further comprises instructions that cause the computer system to determine a quality threshold for the task; and
the instructions that cause the computer system to determine the plurality of microtasks comprise instructions that cause the computer system to determine the plurality of microtasks based upon the risk threshold and the quality threshold.

10. The computer-readable storage medium of claim 1 wherein the instructions that cause the computer system to generate the final work product comprise instructions that cause the computer system to combine a first work product resulting from performance of a first microtask by a human worker and a second work product resulting from performance of a second microtask by a machine worker.

11. The computer-readable storage medium of claim 1 wherein the input information is an image and the task is to recognize a set of words or objects in the image.

12. The computer-readable storage medium of claim 1 wherein the input information is an image and the task is to provide a symbolic representation of the image.

13. A system comprising:
a memory configured to store input information for a task to be performed; and
a processor coupled with the memory, the processor configured to:
determine a risk threshold for the task;
determine, based upon the risk threshold, a plurality of microtasks for performing the task, each microtask associated with a portion of the input information;
cause the plurality of microtasks to be distributed to a plurality of workers;
receive a plurality of work products resulting from performance of the plurality of microtasks by the plurality of workers; and
generate a final work product for the task based upon the plurality of work products resulting from performance of the plurality of microtasks.

14. The system of claim 13 wherein the processor is configured to:
segment the input information into a set of segments based upon the risk threshold, each segment comprising a portion of the input information; and
generate a combined segment based upon the set of segments and the risk threshold, the combined segment comprising information from at least one segment from the set of segments and additional data not included in the input information.

15. The system of claim 13 wherein the processor is configured to:
segment the input information into a set of segments based upon the risk threshold, each segment comprising a portion of the input information; and
generate a set of combined segments based upon the set of segments, the set of combined segments comprising at least one combined segment comprising information from at least two different segments from the set of segments; and
determine the plurality of microtasks based upon the set of combined segments.

16. The system of claim 15 wherein:
the input information comprises a first document and a second document;
the set of segments comprises a first segment comprising a portion of the first document and a second segment comprising a portion of the second document;
the set of combined segments comprises a first combined segment comprising contents of the first segment and the second segment;
the plurality of microtasks comprises a first microtask to be performed using the first combined segment as input.

17. The system of claim 13 wherein the processor is configured to output a quality estimate for the final work product, wherein the quality estimate is based upon quality estimates associated with the plurality of work products resulting from performance of the plurality of microtasks.

18. The system of claim 17 wherein the processor is configured to determine, based upon the quality estimate, if a second set of microtasks is to be determined for the task.

19. The system of claim 13 wherein the plurality workers comprises at least one human worker.

20. The system of claim 13 wherein the processor is configured to generate the final work product by combining a first work product resulting from performance of a first microtask by a human worker and a second work product resulting from performance of a second microtask by a machine worker.

21. The system of claim 13 wherein the input information is an image and the task is to recognize a set of words or objects in the image.

22. A method comprising:
receiving, by a processing system, information identifying a task and input information for the task;
determining, by the processing system, a risk threshold for the task;
determining, by the v system, based upon the risk threshold, a plurality of microtasks for performing the task, each microtask associated with a portion of the input information;
causing the plurality of microtasks to be distributed to a plurality of workers;
receiving, by the processing system, a plurality of work products resulting from performance of the plurality of microtasks by the plurality of workers; and
generating, by the processing system, a final work product for the task based upon the plurality of work products resulting from performance of the plurality of microtasks.
